(19) United States
(12) Patent Application Publication
(10) Pub. No.: US 2025/0329194 A1
(43) Pub. Date: Oct. 23, 2025

(54) METHOD, DEVICE AND SYSTEM FOR MAINTAINING MOVING OBJECT, AND MOVING OBJECT

(71) Applicants: Hyundai Motor Company, Seoul (KR); Kia Corporation, Seoul (KR)

(72) Inventors: Jae Jun Ha, Hwaseong-si (KR); Young Jun Moon, Sejong-si (KR); Tae Hee Lee, Yongin-Si (KR)

(21) Appl. No.: 19/257,195

(22) Filed: Jul. 1, 2025

Related U.S. Application Data
(63) Continuation of application No. 17/408,735, filed on Aug. 23, 2021.

(30) Foreign Application Priority Data
Aug. 24, 2020 (KR) 10-2020-0106497
Jun. 4, 2021 (KR) 10-2021-0072981

(51) Int. Cl. G07C 5/00; G06Q 10/20; G07C 5/12

(52) U.S. Cl. CPC G07C 5/006; G06Q 10/20; G07C 5/12

(57) ABSTRACT

A method of maintaining a moving object for a fleet system includes obtaining monitoring information of parts, analyzing a maintenance level of each of the parts from the monitoring information, checking whether there is a part corresponding to an essential level or a potential level as the maintenance level, and determining whether to maintain the part of the moving object and requesting maintenance of the part according to the determination, when the part reaches the essential level or when the part reaches the potential level and a predetermined condition is satisfied. If at least one of mileage data or use period data of the monitoring information is lower than a standard maintenance value of the part, the maintenance level of the part is able to reach the essential level.

### CROSS-REFERENCE TO RELATED APPLICATIONS

This application is a continuation application of U.S. application Ser. No. 17/408,735, filed on Aug. 23, 2021, which claims the benefit of Korean Patent Application No. 10-2021-0072981, filed on Jun. 4, 2021, and Korean Patent Application No. 10-2020-0106497, filed on Aug. 24, 2020, which applications are hereby incorporated herein by reference.

### TECHNICAL FIELD

The present disclosure relates to a method, device and system for maintaining a moving object, and a shared moving object.

### BACKGROUND

As technology advances, the concept of vehicle ownership has been weakened and use of shared vehicles has increased. Specifically, vehicles are shared in a specific area or residence for convenience of life, and needs to receive services using them are increasing. For smooth use of shared moving objects in an area where a large number of users is densely populated, a large number of shared moving objects may be stored and managed in the vicinity of the densely populated area.

When shared moving objects are popularly activated, it is impossible to finely manage various parts of the moving objects. A privately owned vehicle is smoothly maintained by the owner, but a large number of moving objects is maintained by a single operator. Furthermore, since parts and maintenance elements are directly connected to safety, if timely maintenance is not performed, human accidents may occur. In addition, since the operation rate of the shared moving objects are lowered due to maintenance, the fleet system for managing the moving objects may not assign moving objects in response to use requests from many user devices. Since the moving object includes many parts, if maintenance is performed whenever a problem occurs in a part, the fleet system needs to assign a lot of resources to maintenance and management. Therefore, various methods of performing timely maintenance without causing inconvenience in operation of the shared moving objects have been attempted. Hereinafter, in consideration of the above-described point, there is a need for a method for maintaining moving objects in a fleet system.

### SUMMARY

The present disclosure relates to a method, device and system for maintaining a moving object, and a shared moving object. Particular embodiments relate to a method, device and system for maintaining a moving object, which achieves smooth operation and timely maintenance of the moving object in a fleet system implemented by a computing device, and a moving object.

An embodiment of the present disclosure provides a method, device and system for maintaining a moving object, which achieves smooth operation and timely maintenance of the moving object in a fleet system implemented by a computing device, and a moving object.

The technical problems solved by embodiments of the present disclosure are not limited to the above technical problems and other technical problems which are not described herein will be clearly understood by a person (hereinafter referred to as an ordinary technician) having ordinary skill in the technical field, to which the present disclosure belongs, from the following description.

According to an embodiment of the present disclosure, a maintenance method of a moving object for a fleet system implemented by a computing device includes obtaining monitoring information of parts from the moving object, analyzing a maintenance level of each of the parts from the monitoring information, checking whether there is a part corresponding to an essential level or a potential level as the maintenance level, and determining whether to maintain the part of the moving object and requesting maintenance of the part according to the determination, when the part reaches the essential level or when the part reaches the potential level and a predetermined condition is satisfied. The potential level is lower than the essential level, and, even if at least one of mileage data or use period data of the monitoring information is lower than a standard maintenance value of the part, the maintenance level of the part is able to reach the essential level.

According to another embodiment of the present disclosure, the monitoring information of the part further may include additional data for measuring severe use of the part along with the mileage data and use period data of the moving object.

According to another embodiment of the present disclosure, the analyzing the maintenance level of each part may include calculating a converted value including at least one of a converted mileage or converted use period of each part calculated based on the mileage data, the use period data and the additional data.

According to another embodiment of the present disclosure, the checking whether there is a part corresponding to the essential level or the potential level may include determining the part having a converted value reaching the standard maintenance value as the essential level and determining a part having a converted value reaching a predetermined ratio of the standard maintenance value as the potential level.

According to another embodiment of the present disclosure, the analyzing the maintenance level of each part may include giving a weight to each of a plurality of detailed data belonging to the additional data and calculating the maintenance level of each part based on the mileage data, the use period data and the additional data, to which the weight is given.

According to another embodiment of the present disclosure, the determining the maintenance of the part may include, when the part reaches the essential level and at least one part other than the part having the essential level reaches the potential level, determining maintenance of the parts reaching the essential level and the potential level.

According to another embodiment of the present disclosure, the determining the maintenance of the parts reaching the essential level and the potential level may include determining maintenance of the part having the potential level based on first auxiliary data including at least one of resource information required for maintenance of the part having the potential level or usage state information of the moving object, and the requesting the maintenance of the part comprises requesting maintenance of the part having the essential level, and requesting maintenance of the part having the potential level according to a result of determination.

According to another embodiment of the present disclosure, the requesting the maintenance of the part may include, when the part belongs to a first part class and the part of the first part class reaches the essential level, determining maintenance of the part of the first part class.

According to another embodiment of the present disclosure, the requesting the maintenance of the part may include, when the part belongs to a second part class and the part of the second part class reaches the essential level, determining maintenance of the part of the second part class according to second auxiliary data including at least one of resource information required for maintenance of the part of the second part class or usage state information of the moving object.

According to another embodiment of the present disclosure, the second auxiliary data may be set for each part of the second part class and may further include characteristic information defining a predetermined ratio exceeded from the essential level, and the predetermined ratio may be set not to exceed at least one of a safety level or discomfort level of the moving object for each part of the second part class.

According to another embodiment of the present disclosure, the requesting the maintenance of the part may include, when the part reaching the potential level includes a part of a first part class and the number of parts of the first part class is equal to or greater than a first value, determining maintenance of the part of the first part class.

According to another embodiment of the present disclosure, the requesting the maintenance of the part may include determining maintenance of the part of the first part class based on third auxiliary data including resource information required for maintenance of the part of the first part class or usage state information of the moving object.

According to another embodiment of the present disclosure, when the part reaching the potential level further includes a part belonging to a second part class, maintenance of the parts of the first and second part classes may be determined and requested.

According to another embodiment of the present disclosure, when maintenance of the part of the first part class is determined, maintenance of the part of the second part class may be determined and requested based on fourth auxiliary data including resource information required for maintenance of the part of the second part class or usage state information of the moving object.

According to another embodiment of the present disclosure, the maintenance method may further include receiving, from a user device, a use request of the moving object and accumulated use information of a user, predicting whether the part of the moving object reaches the essential level or the potential level when using the moving object, based on the use request and the accumulated use information, and setting to disallow use of the moving object, when occurrence of a part reaching the essential level is predicted.

According to another embodiment of the present disclosure, the obtaining the monitoring information of the part from the moving object may include obtaining the monitoring information while a user uses the moving object, and the requesting maintenance of the part may include determining maintenance of the part when the part reaches the essential level during use of the moving object, transmitting a return request of the moving object to a user device or setting to execute switching of a control right of the moving object, when the maintenance is determined, and requesting reservation for maintenance of the part.

According to another embodiment of the present disclosure, the maintenance method may further include updating a maintenance information of the moving object when the maintenance of the part is completed after determining and requesting the maintenance of the part.

According to another embodiment of the present disclosure, the maintenance method may further include, when a predetermined number of parts reaches the potential level, ordering the part based on at least one of part status information for inferring a stock of the parts having the potential level or reservation information of the moving object.

According to another embodiment of the present disclosure, the obtaining the monitoring information, the analyzing the maintenance level of each part, the checking whether there is a part corresponding to the essential level or the potential level and the requesting the maintenance may be performed by the moving object.

According to another embodiment of the present disclosure, a moving object for performing a maintenance process of the moving object in a fleet system includes a transceiver configured to transmit and receive a signal and a processor configured to control the transceiver. The processor is configured to obtain monitoring information of parts from the moving object, to analyze a maintenance level of each of the parts from the monitoring information, to check whether there is a part corresponding to an essential level or a potential level as the maintenance level, and to determine whether to maintain the part of the moving object and request maintenance of the part according to the determination, when the part reaches the essential level or when the part reaches the potential level and a predetermined condition is satisfied. The potential level is lower than the essential level, and, even if at least one of mileage data or use period data of the monitoring information is lower than a standard maintenance value of the part, the maintenance level of the part is able to reach the essential level.

According to another embodiment of the present disclosure, a server for performing a maintenance process of a moving object in a fleet system includes a transceiver configured to transmit and receive a signal and a processor configured to control the transceiver. The processor is configured to obtain monitoring information of parts from the moving object, to analyze a maintenance level of each of the parts from the monitoring information, to check whether there is a part corresponding to an essential level or a potential level as the maintenance level, and to determine whether to maintain the part of the moving object and request maintenance of the part according to the determination, when the part reaches the essential level or when the part reaches the potential level and a predetermined condition is satisfied. The potential level is lower than the essential level, and, even if at least one of mileage data or use period data of the monitoring information is lower than a standard maintenance value of the part, the maintenance level of the part is able to reach the essential level.

According to another embodiment of the present disclosure, a fleet system implemented by a computing device to perform a maintenance process of a moving object includes a server configured to manage the fleet system, at least one user device registered in the fleet system, and at least one moving object registered in the fleet system. At least one of the server or the moving object is configured to obtain monitoring information of parts from the moving object, to analyze a maintenance level of each of the parts from the monitoring information, to check whether there is a part corresponding to an essential level or a potential level as the maintenance level, and to determine whether to maintain the part of the moving object and request maintenance of the part according to the determination, when the part reaches the essential level or when the part reaches the potential level and a predetermined condition is satisfied. The potential level is lower than the essential level, and, even if at least one of mileage data or use period data of the monitoring information is lower than a standard maintenance value of the part, the maintenance level of the part is able to reach the essential level.

The features briefly summarized above with respect to embodiments of the present disclosure are merely exemplary aspects of the detailed description below of embodiments of the present disclosure, and do not limit the scope of the present disclosure.

According to embodiments of the present disclosure, it is possible to provide a method, device and system for maintaining a moving object, which achieves smooth operation and timely maintenance of the moving object in a fleet system implemented by a computing device, and a moving object.

It will be appreciated by persons skilled in the art that that the effects that can be achieved through embodiments of the present disclosure are not limited to what has been particularly described hereinabove and other advantages of embodiments of the present disclosure will be more clearly understood from the detailed description.

### BRIEF DESCRIPTION OF THE DRAWINGS

FIG. 1 is a view illustrating a moving object performing communication with another device through a network.

FIG. 2 is a view illustrating sharing of a moving object based on a fleet system.

FIG. 3 is a view illustrating management of a user based on a fleet system.

FIG. 4 is a view illustrating an example of applying an identification device to a moving object.

FIG. 5 is a view illustrating an example of a fleet spot.

FIG. 6 is a flowchart illustrating a moving object assignment and maintenance process by a fleet system.

FIG. 7 is a view showing an example of moving object overview information.

FIG. 8 is a view illustrating an example of performing maintenance level analysis and maintenance request between a moving object and a server.

FIGS. 9A and 9B are flowcharts illustrating a maintenance method of a moving object according to an embodiment of the present disclosure.

FIG. 10 is a view illustrating an example of basic information of each part of a moving object.

FIG. 11 is a view illustrating a moving object module for measuring a maintenance level of a brake pad and a process of transmitting monitoring information.

FIG. 12 is a view illustrating an example of maintenance information of a moving object.

FIGS. 13A and 13B are views illustrating an example of a maintenance level.

FIG. 14 is a flowchart illustrating a moving object assignment process according to another embodiment of the present disclosure.

FIG. 15 is a flowchart illustrating a moving object assignment process according to another embodiment of the present disclosure.

FIG. 16 is a flowchart illustrating a maintenance determination and moving object control method while using a moving object according to another embodiment of the present disclosure.

FIG. 17 is a flowchart illustrating a part ordering method according to an embodiment of the present disclosure.

FIG. 18 is a view illustrating the configuration of a device according to an embodiment of the present disclosure.

### DETAILED DESCRIPTION OF ILLUSTRATIVE EMBODIMENTS

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In embodiments of the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In embodiments of the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In embodiments of the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In embodiments of the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of embodiments of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

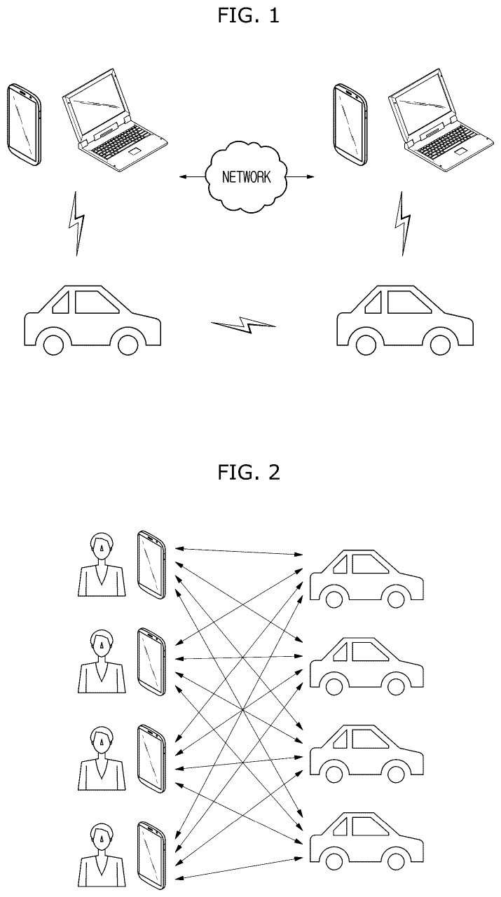

FIG. 1 is a view illustrating a moving object performing communication with another device through a network.

Referring to FIG. 1, the moving object may perform communication with another moving object or another device. For example, the moving object may perform communication with another moving object or another device based on cellular communication, WAVE communication, dedicated short range communication (DSRC) or another communication method. That is, as the cellular communication network, a communication network such as LTE or 5G, a Wi-Fi communication network, a WAVE communication network, etc. may be used. In addition, a short-range communication network used in a moving object, such as DSRC, may be used, but the present disclosure is not limited to the above-described embodiment.

In addition, for example, in relation to communication of the moving object, for security of the moving object, a module capable of performing communication with a device located inside the moving object and a module capable of performing communication with a device located outside the moving object may be separately provided. For example, in a moving object, communication with only a device in a predetermined range of the moving object, such as Wi-Fi communication, may be performed based on security. For example, the moving object and the personal device of the driver of the moving object may include communication modules for performing communication between each other. That is, the moving object and the personal device of the driver of the moving object may use a communication network blocked from an external communication network. In addition, for example, the moving object may include a communication module for performing communication with an external device. In addition, for example, the above-described modules may be implemented as one module. That is, based on one module, the moving object may perform communication with another device, but the present disclosure is not limited to the above-described embodiments. That is, in the moving object, a communication method may be implemented based on various methods, but the present disclosure is not limited to the above-described embodiments.

In this case, the moving object may refer to a movable device, for example. For example, the moving object may include a vehicle (including an autonomous vehicle or an automated vehicle), a drone, personal mobility, a mobile office, a mobile hotel or a personal air vehicle (PAV). The personal mobility may include, for example, a moving object including at least three wheels for stable independent traveling or a moving object which has one or two wheels but can be driven independently while maintaining balance (e.g., a single-wheel Segway, a two-wheel Segway, an electric kickboard, etc.). The personal mobility may use electricity using a battery as a power source, but is not limited thereto and may use any type of power source capable of moving the mobility. For example, the personal mobility may mean a means of transportation in which only one user rides or a means used by only one user. In addition, the personal mobility may mean a small means of transportation which may be used by a small number of users. For example, the personal mobility may include not only a single-wheel Segway, a two-wheel Segway and an electric kickboard but also an electric wheelchair, an electric bicycle and an electric two-wheeled vehicle. In addition, the moving object may include the other moving devices and is not limited to the above-described embodiments.

FIG. 2 is a view illustrating sharing a moving object based on a fleet system.

For example, a fleet system may be applied to provide a moving object sharing service. The fleet system may be operated by data generation, processing and exchanging between computing devices. The fleet system may include, for example, at least one server, a plurality of user devices and a plurality of moving objects. The server may process a request of a user device, transmit a response message, process a reservation, assignment/return of a moving object according to the request, and manage the moving object, for a fleet service. In addition, the server may receive moving object state information and maintenance information from the moving object, generate overall moving object status information, and perform overall management of information related to the moving object and maintenance of parts of the moving object.

In addition, the fleet system may include a plurality of devices and a plurality of moving objects. In addition, for example, the fleet system may further include a road side unit (RSU), etc. The device may include a smartphone, a smart pad, a smart watch, etc. As another example, the device may mean a device capable of exchanging signals through the other communication, but is not limited to the above-described embodiment. However, hereinafter, for convenience of description, this is referred to as a device or a user device. In addition, for example, the moving object may be a vehicle. In addition, for example, the moving object may be an object moving in a provided area such as a rail. As another example, the moving object may be a flying object such as a drone. That is, the moving object may refer to a movable object and may mean a moving object shared based on the fleet system. However, although the vehicle will be described below for convenience of description, this is equally applicable to the other moving objects. As another example, the RSU is a road side unit and may be a device capable of performing communication. In addition, for example, the RSU may refer to a structure installed to transmit and receive signals to a building or another area and is not limited to the above-described embodiment. However, hereinafter, this will be collectively referred to as the RSU for convenience of description and may be various structures or devices and is not limited to the above-described embodiment.

In addition, the fleet system may be a moving object sharing system. The fleet system may be a system in which a moving object is shared in a predetermined area. The predetermined area may have the local concept such as apartment complex or a work area. For example, the predetermined area may be an area in an apartment complex or an area separated from the apartment complex by a preset distance. As another example, the predetermined area may mean an area separated from a work area by a preset distance. As another example, an area to which the fleet system applies may be a larger area or a city unit, such as an administrative district, and is not limited to the above-described embodiment. That is, the predetermined area may mean a reference range in which operation based on the fleet system is possible, and may be changed by a user or a system. In addition, for example, the fleet system may be a system in which the moving object is shared by users authenticated as specific users (or devices). For example, the specific user may be a resident of an apartment in a predetermined range in which the service of the fleet system may be provided or a worker of an office located in a specific area. For example, the specific user may be a person subscribing to the fleet system providable in a predetermined service area and may be a user outside the service area. Such a user may try to approach a certain service area to use a sharing service. For example, the fleet system may provide the moving object sharing service based on a device registered by the resident of the apartment or the worker of the office. Therefore, it is possible to provide the sharing service to only the specific target and to increase moving object security and management efficiency. However, the specific user who uses the shared moving object in the fleet system may be determined based on the other method, and is not limited to the above-described embodiment.

The shared moving object fleet system may be provided with a shared moving object. The shared moving object may be a moving object authorized or authenticated to be shared by the system. For example, the shared moving object may be a moving object registered in the fleet system. A fleet system administrator may provide the shared moving object for the fleet system. That is, only the moving object authorized or authenticated by the fleet system administrator may be used as the shared moving object. Therefore, it is possible to prevent accidents which may occur due to security or management of the shared moving object in the fleet system. More specifically, the moving object to be shared may be registered in the fleet system. The right to register the shared moving object in the fleet system may be restricted by the fleet system. The moving object which may be registered in the fleet system may have the same ID or the same identification information. In addition, since the fleet system provides the shared moving object, the shared moving object may be managed. For example, management of the shared moving object may be information necessary to provide a shared moving object service, such as residual oil information of the moving object registered in the fleet system, moving object status information or moving object operation information. The fleet system may check the status of the shared moving object in real time, control authority for use or transmit a command for maintenance through the system with respect to a moving object in which a problem has occurred and provide a service based on this.

As another example, the fleet system may provide a mixture of a shared moving object and a private moving object. For example, the fleet system may set identification information for identifying the shared moving object provided by the system and the private moving object, for example, a moving object possession indication field. When a value other than the private moving object is recorded in the indication field, the shared moving object may be indicated as a moving object provided by a system provider without private possession. On the other hand, when a value indicating the private moving object is recorded in the indication field, this may indicate that the moving object is privately possessed and the moving object is provided to the fleet system as the shared moving object. The case where the private moving object and the shared moving object provided by the system are mixed may also be considered. For example, the service provided by the fleet system may vary based on the moving object possession indication field. For example, in the case of the moving object provided by the fleet system, there may be no restriction on the use of a user who uses the moving object. On the other hand, in the case of the private shared moving object, there may be use restriction. As another example, the fleet system moving object and the private shared moving object may provide services based on different charging systems, and is not limited to the above-described embodiment.

As another example, in relation to the detailed operation of the fleet system, a service may be provided based on a device registered in the fleet system.

More specifically, the device registered in the fleet system may obtain information on the shared moving object after an authentication and security procedure with the system. That is, the device may be provided with the information on the shared moving object. The device may be brought into contact with the moving object to be used based on the information on the shared moving object.

For example, there may be a registered moving object or a registered device (or user) in the fleet system. That is, only a specific moving object and device may be registered in the fleet system based on authentication and authorization. In this case, the fleet system may be operated based on the status information of the registered moving object and the registered device. For example, the fleet system may check information on a moving object which is currently being used and position information of an individual moving object in real time. For example, each moving object may periodically transmit information thereof to the fleet system. In addition, for example, each moving object may transmit information thereof to the fleet system based on an event trigger. For example, when an event in which the position of the moving object is changed or whether to use the moving object is changed is triggered, the moving object may transmit information thereof to the fleet system (or the server). In addition, the fleet system (or the server) may check information on the registered device in real time. For example, the registered device may not always use the service of the fleet system. Accordingly, activation information indicating whether the registered device uses the service of the fleet system may be necessary. For example, the fleet system may include information on a list of registered devices. A device which is currently using the moving object or activates the system for use of the moving object among the registered devices included in the list of the fleet system may be provided together with the list information. As another example, a registered device (deactivated device) which does not use the fleet system, a registered device (activated device) which is using the moving object of the fleet system and a registered device (temporary device) which wants to use the moving object may be distinguishably displayed. That is, information on whether the moving object is actually being used, whether there is no intention of using the moving object or whether there is an intention of using the moving object but the moving object is not yet used may be provided. In addition, for example, usage state information may be further indicated with respect to the device which is using the moving object of the fleet system. For example, the usage state information may further include expected use time information or use position information.

More specifically, the fleet system may include list information of a plurality of registered moving objects and a plurality of devices. In this case, the list information may include at least one of moving object overview information, usage state information, device position information or moving object position information. In this case, the fleet system may provide a moving object sharing service based on the device position information and the moving object position information.

In addition, the moving object overview information is schematic status information generated from use of the moving object and may include, but is not limited to, a moving object type, an accumulated use period, an accumulated mileage, a cleanliness state, part state information, the number of accidents, a maintenance level, and a moving object level. The moving object overview information is stored and updated in the server and the moving object, and may be provided to a device by the request of the user device. In addition, the moving object overview information may be information determining whether the moving object may be provided for sharing of the moving object.

In addition, the usage state information may include at least one of information on a moving object in use, expected time information of a moving object in use, device-moving object matching information, deactivated device information, activated device information, activated moving object information or deactivated moving object information. In this case, for example, the usage state information may further include information on a moving object currently used by another device and expected time information of a moving object in use. In addition, the usage state information may further include device-moving object matching information based on information in the form of a list. In addition, the usage state information may include activated device information and deactivated device information. For example, the activated device information may be a device which is currently using the moving object or a device which is preparing for using the moving object among devices registered in the fleet system, as described above. For example, the activated device may mean a device which has executed a program or application for the fleet system. Meanwhile, the deactivated device may be a device which is registered in the fleet system but does not use sharing of the moving object. For example, the deactivated device may be a device which did not execute or deactivate the program or application for the fleet system.

In addition, the fleet system may include activated moving object information and deactivated moving object information. In this case, for example, the fleet system may include status information of a plurality of moving objects. In this case, the status information of the moving object may be information on whether the moving object is normal or abnormal or information on the moving object such as remaining traveling distance information or refueling time information. That is, the status information of the moving object may be information for determining whether the moving object may be provided for sharing of the moving object, and is not limited to the above-described embodiment. In this case, the fleet system may determine whether the moving object is activated based on the status information. For example, the fleet system may classify a moving object which is in a normal state and has a sufficient amount of oil as an activated moving object and provide information. On the other hand, the fleet system may classify a moving object which is in an abnormal state as a deactivated moving object. In this case, the fleet system may provide information on the deactivated moving object to an associated system or server. For example, the associated system or server may perform repair or management with respect to the deactivated moving object, and is not limited to the above-described embodiment.

In addition, for example, the fleet system may classify a moving object having a predetermined amount of oil or less as a deactivated moving object. As another example, when a moving object having a predetermined amount of oil or less is shared through a device, the fleet system may provide information on the amount of oil to a device user through a notification. In addition, for example, the fleet system may provide information on an associated designated system (e.g., a gas station of a particular brand) to a user and provide information indicating that refueling is required. In this case, the fleet system may exchange charging or other necessary information with the associated designated system regardless of the user and provide a service based on this.

That is, a user who uses a moving object sharing system may refuel at a designated place without paying a fee and handle the fee through a system linked to the fleet system. Meanwhile, for example, as described above, a device (temporary device) which wants to use the moving object may use the moving object by checking the fleet system.

For example, the device may be assigned a moving object to be used through the fleet system. In this case, for example, the fleet system or the server may assign the moving object to the device using at least one of moving object overview information, information on a moving object in use, position information of the moving object or position information of the device. Meanwhile, for example, the fleet system may provide information on failure to the device when the moving object cannot be assigned. In addition, for example, the fleet system may assign only a moving object within a certain distance based on the position of the device, and is not limited to the above-described embodiment. Next, the device may approach the moving object within a certain distance. In this case, the device may transmit an authentication signal to the moving object. In addition, for example, the device may use the shared moving object through a tag on the shared moving object based on a list of available moving objects. For example, the device may perform tagging with respect to the moving object based on magnetics such as NFC, Bluetooth or transportation card. In this case, when the device is tagged, the shared moving object may perform an authentication procedure from the fleet system such that the device provides the moving object. For example, when authentication is completed based on the device tag, the door of the moving object may be opened.

In relation to a detailed authentication operation, when the device approaches the moving object within a certain distance, an authentication signal may be transmitted to the moving object. In this case, communication which may be used by the moving object and the device may be Bluetooth, NFC or a tag as described above. That is, an authentication procedure may be performed under a certain condition, and is not limited to the above-described embodiment. When the device approaches the moving object or performs tagging, the moving object and the device may determine whether the device can use the moving object through signal exchange and perform authentication. In this case, the device may transmit an authentication signal including identification information thereof and identification information of a group, to which the device belongs, to the moving object. In this case, the moving object may determine whether the device is registered in the fleet system based on the identification information of the device included in the received authentication signal. In addition, the moving object may determine whether the device is included in a group, to which a service is capable of being provided by the moving object, based on the identification information of the group included in the authentication signal. That is, the moving object may determine whether the device may use the moving object based on device identification information and group identification information. For example, when the device may not use the moving object, the moving object may transmit information indicating that the device is unavailable. For example, the device may obtain information indicating unavailability from an application or other service provision program.

Meanwhile, when the device may use the moving object, the moving object may transmit a signal for a request to perform an authentication procedure to the device. That is, when the device is legally registered in the fleet system (or the server) and the moving object may also legally operate based on the fleet system, the moving object may transmit the signal for the request to perform the authentication procedure to the device. In this case, the moving object may transmit the signal for the request to perform an authentication procedure, including identification information thereof and encryption key information, to the device. For example, both the identification information of the moving object and the device information may be registered in the fleet system. In this case, the moving object may transmit a signal including the identification information of the moving object, the identification information of the device and the encryption key information to the fleet system.

In addition, the device may also transmit, to the fleet system, a signal including the identification information of the moving object, the encryption key information and the identification information thereof included in the signal for the request to perform the authentication procedure.

Thereafter, the fleet system may compare the signal received from the moving object and information included in the signal received from the device. In this case, when all the identification information of the moving object, the identification information of the device and the encryption key information are the same, the fleet system may recognize that the device may use the moving object. Thereafter, the fleet system may transmit authentication confirmation information to the moving object and the device. In this case, the fleet system may register information indicating that the device uses the moving object in a database. In addition, for example, a time when the device uses the moving object and additional information may also be continuously transmitted.

In addition, the moving object may register the device based on the authentication confirmation information and the door of the moving object may be opened. In addition, a lock for using the moving object may be unlocked to allow the device to control the moving object.

In this case, for example, when the above-described authentication is completed, the moving object and the device may periodically exchange signals. That is, while the device uses the moving object, the moving object may continuously confirm use through periodic signal exchange with the device. In addition, the moving object may transmit and receive monitoring information of each part and maintenance-related information to and from the server through periodic data exchange with the server during use, and the server may also transmit and receive requests and information related to maintenance to and from the moving object.

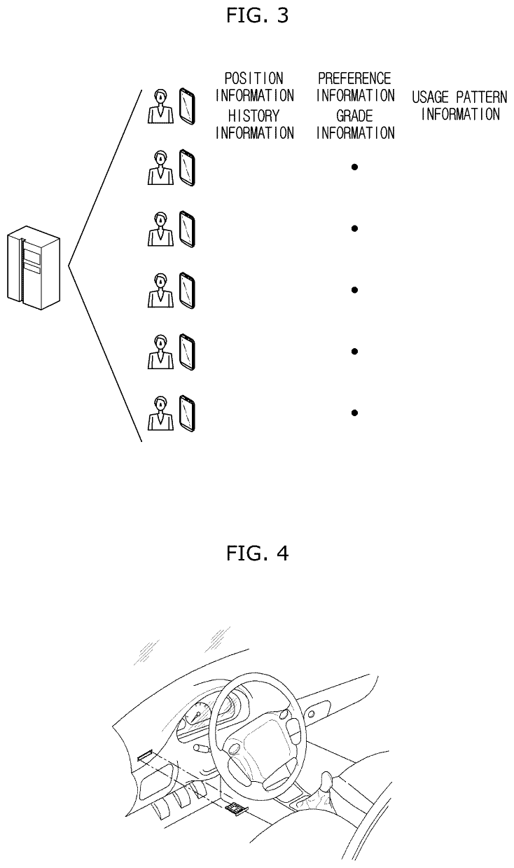

FIG. 3 is a view illustrating managing a user based on a fleet system.

For example, based on the above description, the moving object and the device may be managed in the fleet system. In this case, for example, in the fleet system, information on each user may be managed. For example, information on each user may be information on user usage based on a user ID or a user identification device. As a more specific example, information on each user may include at least one of user position information, user history information, preference information, usage status information, grade information or usage pattern information.

For example, the user position information may be information for checking a mainly used path of a user who uses the fleet system. For example, the user position information may be static position information set by a user, such as a user's residence and work place and dynamic position information such as position information at the time of request for use and position information at the time of use. In addition, for example, the fleet system may store user history information.

The history information may be user tendency information analyzed based on the type of the moving object used by the user, an area of use of a fleet spot provided to the fleet system, a moving route, a destination point, or a parking point during use. For example, the fleet system may perform recommendation for use of the moving object based on the user history information. In addition, for example, the fleet system may perform management for moving object assignment and distribution using the history information of a plurality of users.

In addition, for example, the fleet system may include user preference information. For example, the user preference information may be information considering the frequency or preference of the used moving object. Specifically, the preference information may be the type of the moving object which is designated or estimated to be preferred by the user. In addition, for example, the user preference information may be input by a user, and is not limited to the above-described embodiment.

In addition, for example, the fleet system may provide the grade information of the user. The grade information may be given to each user based on use situation information including subscription information of the fleet system and usage result information and evaluation information after using the moving object. For example, the subscription information may be related to whether a user makes a long-term contract or subscribes to a premium membership as a contract condition for the service of the fleet system. The usage result information may include a frequency of using the moving object, use cost according to a time or distance, etc. When the user frequently uses the moving object, the grade level may increase. For example, the evaluation information may be generated based on the clean state after using the moving object, maintenance occurrence due to accidents and inappropriate use of the moving object, rapid increase in consumption of moving object parts due to a user's inappropriate use such as sudden stop/overspeed. The evaluation information may be calculated or estimated by a subsequent user, a maintenance center after return or the above-factors of various sensors mounted in the moving object during/after use. In addition, in the evaluation information, when the subsequent user or an administrator determines inappropriate use due to a user's smoking or behavior causing a bad smell or when such a determination is accumulated, the grade level may decrease. In addition, in the evaluation information, when the moving object is used without an accident or is continuously used well so that unnecessary maintenance does not occur, the grade level may increase. The evaluation information may be created for each user based on the usage status information of the moving object generated from the used moving object and the server.

In addition, the fleet system may provide usage pattern information of the user. The usage pattern information may be generated by collecting at least one of life pattern information or riding pattern information of each user. For example, the life pattern information may be generated based on at least one of consumption information of the user, a destination point when the moving object was used in the past or a stopping point when the moving object was used in the past. The riding pattern information may be configured based on at least one of the use area and parking surface of the moving object, the average number of passengers of the moving object, the age and gender of the passenger or passenger body information. The fleet system may determine at least one zone suitable for the user in the large-area fleet spot in consideration of the usage pattern information and assign a moving object disposed in the zone. In addition, the fleet system may analyze the usage pattern information, determine an optimal parking surface according to the usage pattern of the user and the zone of the fleet spot, to which the moving object will be returned, and notify the user of it when the moving object is reserved.

The above-described various information may be stored in and managed by a server for controlling the fleet system, for example. As another example, at least some of the information may be stored in an identification device mounted in or tagged on the moving object or a user device which may communicate with the system in the moving object. The identification device may be used to identify and authenticate the user who makes a reservation when the user uses the assigned moving object. The identification device may transmit data for control of the moving object to the moving object and the fleet system (server) in addition to the purpose for authentication. For example, the identification device may store the grade information of the user and apply benefit information and penalty information (hereinafter referred to as benefit and penalty) according to the grade level of the user to control of the moving object. In addition, the identification device may detect a user's inappropriate use through a sensor mounted in the moving object, store and transmit evaluation information determined in real time to the server, and enable the server to update the evaluation information. In addition, the identification device may collect and transmit life pattern information such as real-time movement path, a destination point and a stopping point of the moving object to the server and enable the server to update the life pattern information or to change a return zone and a parking surface designated at the time of reservation. In addition, the identification device may obtain riding pattern information different from that at the time of reservation, transmit it to the server, and enable the server to update the riding pattern information or to change the return zone and the parking surface designated at the time of reservation.

The form of the identification device is shown in FIG. 4. FIG. 4 is a view illustrating an example of applying an identification device to a moving object.

The identification device may have at least one of functions for identifying a user, a control target or a service target. In addition, for example, the identification device may have an ID function. In addition, the identification device may be at least one of a smart device, a smart module, a user identification module or an identification module. That is, the identification device may be a hardware component. In addition, the identification device is a software component and may be used for identification. At this time, for example, the identification device may be a SIM (Subscriber Identity Module). For example, the SIM applied to the moving object as the identification device may include at least one of a Mobility SIM (M-SIM) or a Vehicle SIM (V-SIM). In addition, for example, the identification device may be equal to or compatible with the existing SIM, and is not limited to the above-described embodiment.

As described above, the identification device may be applied to the moving object in consideration of the case where the moving object performs communication with an external device. For example, a universal subscriber identification module (USIM) may is installed in a user device phone, such that a user is recognized through the USIM to provide a service. The moving object may have an identification device card installed therein based on the above description. For example, the identification device applied to the moving object may be referred to as a Vehicle SIM (VSIM). That is, a new type of the identification device is applicable as the identification device applied to the moving object. For example, the VSIM may be compatible with the USIM or another SIM. In addition, the VSIM may further provide another service in consideration of the characteristics of the moving object, and is not limited to the above-described embodiment.

As shown in FIG. 4, there may be a part, to which the identification device is applied, in the moving object. At this time, FIG. 4 shows one example of applying the identification device, and is not limited to the above-described embodiment. More specifically, as shown in FIG. 4, there may be a part, to which the identification device is applied, in a visually identified part of the driver's seat of the moving object. Although not shown, as another example, the identification device may be applied to the glove box located at the passenger's seat of the moving object. As another example, the identification device may be inserted into a part in which the display of the moving object is present, but this is not limited to the above-described embodiment, and there may be a slot, in which the identification device may be accommodated, at an appropriate part inside or outside the moving object. As another example, in consideration of portability of the identification device, the identification device may be implemented in combination with a tool key or a car key. That is, the identification device may be mounted in the tool key or the car key, and the identification device detached from the car key may be mounted in the moving object to be used. The tool key or the car key may perform communication with the moving object through short-range communication (e.g., Bluetooth, beacon or NFC). Therefore, message exchange may be performed and identification may be performed. That is, the car key or tool key reflecting uniqueness of an individual may be used as the identification device, and is not limited to the above-described embodiment.

As another example, the above-described identification device may be mounted through an existing device mounted in the moving object. For example, the existing device (e.g. a road payment terminal or black box) may be already installed in the moving object. As another example, the identification device may be recognized through an existing terminal (e.g., a USB port or a cigarette jack) included in the moving object.

As another example, the identification device is applicable to any position in a range in which authentication is possible in the moving object, and the identification device may be integrally or detachably applicable to a control unit, communication unit or part of the moving object.

Meanwhile, the storage of the moving object and the identification device embedded in the moving object may have at least one of the overview information or maintenance information of the moving object. The moving object overview information may be status information including data accumulated in the process of using the moving object and data on a current state, as described above. The maintenance information may include mileage data (or driving distance data, travelling distance data) of the moving object, the use period data, and basic information related to maintenance of each part of the moving object. In addition, the maintenance information may include the maintenance level of each part analyzed from the monitoring information of the moving object, resource information (e.g., maintenance time, part acquisition time or waiting time) required for maintenance of each part and usage state information including the reservation state of the moving object. The moving object overview information and the maintenance information may be shared with the server or the server may generate, retain and transmit the above-described information to the moving object to perform the maintenance process.

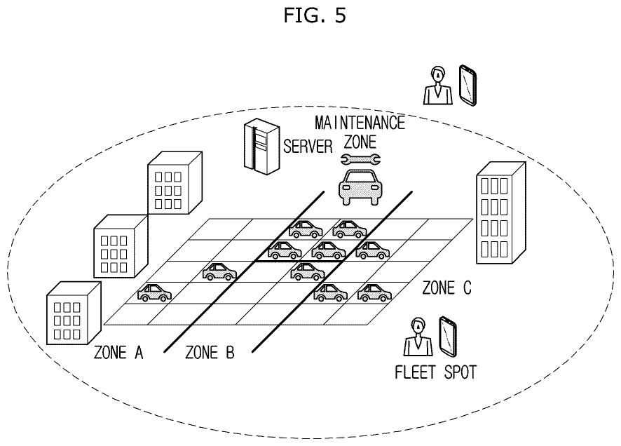

FIG. 5 is a view illustrating an example of a fleet spot.

The fleet system may be operated with a fleet spot where a shared moving object is capable of being assigned or returned. The fleet spot may be an area where the shared moving object is stored in a predetermined area to provide a service. For example, the predetermined area may be located near an area where residential districts and/or commercial districts are concentrated. This is to increase convenience of the service provided by the fleet system to people who use buildings near the residential and/or commercial buildings accommodating a large number of people or with a large floating population. People who may use the fleet system may include not only people who reside in the buildings but also people who use the fleet system for a variety of purposes, such as people who visit an area around the fleet spot or transfer to another moving object through the fleet spot.

The fleet system according to embodiments of the present disclosure may be operated with a small number of moving objects or a large number of moving objects for service expansion and convenience through the fleet system. When being operated with a large number of moving objects, the fleet spot may have a large area in order to accommodate various kinds of moving objects. When the fleet spot is operated as a large-area space, a plurality of moving objects may be disposed to be uniformly accommodated in the large space and may be disposed in consideration of the buildings around the fleet spot, the number of resident people or a floating population. Therefore, the fleet spot may be partitioned into a plurality of zones, as shown in FIG. 5, in order to efficiently manage the plurality of moving objects. Each zone may be assigned an accommodation area and a parking surface in consideration of information on the vicinity of the zone, such as the buildings around the fleet spot, the number of resident people or a floating population. For example, in zone A which is located near an area where commercial buildings are concentrated, in consideration of the number of residents of the building, the number of visitors, expected purposes of shared moving objects (e.g., business trips, delivery, private usage, etc.), average use status of shared moving objects (e.g., clean usage, light maintenance request frequency, long-distance movement, the average number of passengers), as the type of the moving object, medium or small sedan-style vehicles, vehicles which can accommodate 7 to 11 people, personal mobilities may have a large proportion and large luxury sedan-style vehicles may be assigned at a relatively low rate. In addition, the medium and small vehicles may be assigned to Zone A such that medium to excellent levels have a relatively larger proportion than a best level in terms of the detailed type of the moving object such as a production year and cleanliness, and the large luxury vehicles are assigned such that excellent to best levels have a relatively large proportion. As another example, in the case of zone D near the residential area, the shared moving objects are mainly used for private purposes such as shopping, commuting, family sharing and personal lifestyles, and cleanliness and a maintenance request frequency may be relatively excellent. Based on this, small and large sedan-style vehicles and vehicles which can accommodate 7 to 11 people may be uniformly assigned to zone D, and vehicles with excellent to best levels in terms of the production year and the cleanliness have a relatively large proportion.

As another example, a maintenance or inspection zone may be disposed in the zones of the fleet spot. For example, when there is no reservation for a moving object to be returned for a predetermined time and the fleet system determines that inspection of the moving object is necessary or when the fleet system determines that urgent maintenance is required based on the moving object status information although there is a next reservation, the fleet system may induce the user of the moving object to return the moving object to the maintenance zone instead of the return zone. As another example, when the fleet system determines that maintenance of an unused moving object parked in a non-maintenance zone is required, the fleet system may move the moving object to a pre-designated zone in an unmanned or manned manner. At this time, the pre-designated maintenance zone may be a place where maintenance and management of the moving object are performed, such as a moving object repair shop, a car wash or a moving object interior cleaning company.

The maintenance zone may include the above-described server (e.g., a management server) and a separate maintenance server, and, when parts are maintained by referring to transmitted maintenance information by the request of the moving object and/or the server, the maintenance server may generate and transmit maintenance information related to the maintained parts to the moving object and the server. The moving object and the server may update the maintenance information of the moving object based on the transmitted information. The maintenance server may generate and manage the maintenance information of all moving objects, all maintenance scheduling information and stock information of parts as maintenance information, but is not limited to the enumerated information.

As another example, the fleet system may manage the moving objects by grouping them in a predetermined number of units. Specifically, the fleet system may process moving objects assigned to a user group or an exclusively assigned moving object group to be mainly accommodated in a specific zone of the fleet spot according to the request of the user device.

In addition, the fleet system may perform maintenance and management of the moving object in group units. In the above-described example, when the maintenance zone is a repair shop or a car wash, a designated area (a repair shop, a car wash, a vehicle interior cleaning company, etc.) for maintenance and management of the moving object for each moving object group may be set. That is, when maintenance and management of the moving object are required, the fleet system may move the moving object to the designated area for each group in a manned or unmanned manner such that maintenance and management of the moving object are performed. By performing maintenance and management of the moving objects for each moving object group, it is possible to perform maintenance and inspection of a larger number of moving object within a limited time.

As another example, in the fleet system, a support unit for maintenance and management of the moving object may be disposed for each moving object group, such that maintenance and inspection of the moving object may be rapidly performed during inspection. For example, the support unit may be a maintenance vehicle disposed for maintenance and management of the moving object.

The fleet system may be, for example, operated, such that a central server manages moving object assignment/return state, moving object status information related to a position and usage state, zone rearrangement of the moving object for each zone and processes a variety of information for each user. As another example, in the fleet system, a slave system in charge of each zone may be disposed to process and manage a task related to the moving object and to receive a user's request for use, such that tasks until a moving object of a specific zone is assigned and a variety of information on each user are managed by the central master server. The master server may receive the result of processing the task related to the moving object using the slave system and update information on each user. Hereinafter, although, for convenience of description, the central server processes information on each moving object and user and manages all zones, such processing may be performed in the master server and the slave system.

In principle, the fleet system is operated such that the moving object is rented in the fleet spot and is returned in the corresponding zone, but may be flexibly operated such that the moving object is returned to a zone other than the corresponding zone according to user grade information or usage pattern information. In addition, the fleet system may allow return to a heterogeneous fleet system in consideration of a premium service type used by a user, a temporary request and grade information.

Although the zones are shown as being arranged adjacent to each other on the ground in FIG. 5, the zones may be spaced apart from each other in a range in which users easily move on foot or using short-distance personal mobilities according to the distribution of surrounding buildings and populations. As another example, the zones may be provided on the ground or may be set on each floor of a multi-story building facility or in a plurality of areas defined for each floor in order to increase the usability of the ground.

Hereinafter, a fleet system implemented by a computing device assigning a shared moving object and performing a maintenance process will be described.

The fleet system may include an application or program for assigning and managing moving objects and generating and managing various information related to users, which is collectively referred to as an application for convenience of description. The application may perform an assignment and management process based on requests and data transmitted among a user device, a shared moving object and a server. In addition, the application may perform the maintenance process of the moving objects based on the above-described request and data. Such an application may be installed in all of the user device, the shared moving object and the server, such that the server obtains information generated from each computing device to perform the process. Hereinafter, for convenience of description, it is assumed that the assignment and management process of the moving objects is mainly performed by the server, and a series of operations for requesting maintenance in the maintenance process is mainly performed by the moving object. However, in order to secure the storage space of the server memory, data generated by using the moving object is accumulated and aggregated in the user device and/or the shared moving object and data accumulated up to the time of the request may be transmitted to the server according to the request of the server. In addition, the maintenance process may be performed such that the server performs operations related to the request for maintenance based on the monitoring information received from the moving object. In the following description, the operations of the moving object may be substantially applied to and implemented in the server unless technical contradiction occurs.

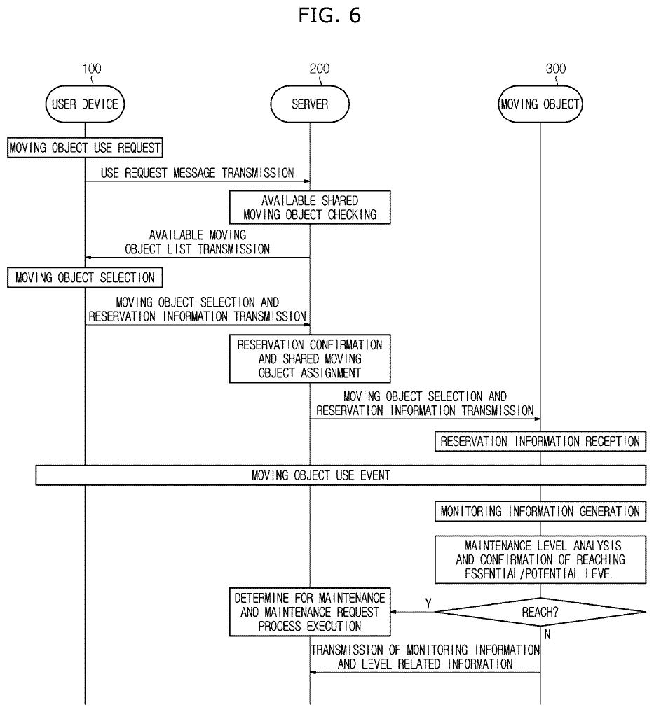

FIG. 6 is a flowchart illustrating a moving object assignment and maintenance process by a fleet system.

First, a user device 100 may request use of a moving object from a server 200 of the fleet system. A use request may include at least a moving object use time, and a use request transmitted to the server 200 may be a message generated based on the moving object use time. For example, a use request message may be generated by further including user position information along with the moving object use time. The user position information may be, for example, a residence or work place registered by a user. In addition, the user position information may be position information at the time of requesting use checked through the user device or dynamic position information input as an expected position when the user uses the moving object. For example, when the position information is set to the residence or work place initially or later, the position information may be determined. As another example, when position information at the time of use request or position information at the time of scheduled use is separately selected and input instead of the residence or work place, the position information may be set to the selected position.

The use request may be a message including at least one of a moving object type, history information, preference information, grade information or usage pattern information, in addition to the moving object use time. The moving object type may be the type of the moving object selected by the user device at the time of request and a detailed classification. The type may include small to large sedan-style vehicles, SUVs, vehicles with 7 to 11 passengers, luggage carriers, personal mobilities, etc. The classification may include maker, detailed model, a production year, cleanliness, good maintenance state, etc. of the moving object. The history information, the preference information, the grade information and the usage pattern information are described above and detailed descriptions thereof will be omitted. The user device may preset whether the above-described information is included through the application and program provided by the fleet system. If it is preset, the use request may be a message based on the moving object use time and information set in the user device, except for user position information. Even if it is preset, when the user device requests generation of the use request message including the position information along with the setting information and the use time at the time of additional settings or requests, the use request message may be generated to include all the above-described information or may be generated based on position information requested by the user prior to estimated position information of the user inferred from the setting information.

Next, the fleet system (or the server) may determine at least one zone suitable for the use request and check a list of available moving objects including available moving objects of the zone.

When the use request is a message generated as the moving object use time and the user position information, the server may check the moving objects of each zone available at a use time by referring to moving object use scheduling and sequentially align the moving objects from a closest zone to a gradually separated zone according to the user position information among zones in which available moving objects are checked. A predetermined number of moving objects may be aligned.

As another example, the use request may be a message generated as a combination of position information and other information or other information without position information, along with a moving object use time. For example, when the position information is not included and the other information is at least one of history information or preference information, the server may search for a moving object type identified from the history information and/or the preference signal and a moving object suitable for a past/preferred use zone of a fleet spot in use scheduling. The server may select an available moving object corresponding to a type in the searched zone. Here, when there is no moving object corresponding to the use zone and the moving object type at the moving object use time, the server may match a zone close to the use zone and type with the moving object. In addition, when the history information further includes at least one of a movement route, destination point or parking point of the user during use, the server may generate history information by giving a weight to the movement route, the destination point and the parking point which frequently occur, rather than one-time occurrence. The server may analyze the user's purpose of using the moving object, for example, long-distance driving, a business trip for a company visit, or a personal purpose such as shopping or a home visit, using the generated history information. When it is analyzed as a business trip through long-distance driving using the history information, the server may check, for example, available sedan-type moving objects of medium or less, latest models and lower mileages in all zones. In addition, the server may further consider the moving object type and the use zone. In this case, a zone and a moving object suitable for the type and the use zone may be selected from among the moving objects checked based on the use purpose. Meanwhile, when the use request is generated as a message, in which the history information and/or the preference information are combined with the user position information, to determine a zone, the user position information may be set to take precedence over the use zone of the history information and/or the preference information. Accordingly, the server may select an available moving object in order from a zone closest to the position of the user position information to a distant zone from among the moving objects checked by the history information.

As another example, other information of the use request may be grade information. The use request may be a message generated as a combination of the user position information and the grade information or grade information with the position information, together with the moving object use time. The server may check a benefit and a penalty given to a user who has requested use according to the grade level of the grade information and determine an assignment condition of the moving object based on the checked benefit and penalty. For example, the server may determine an available moving object and a zone of the moving object satisfying the assignment condition including the type, specification, production year, cleanliness and assignment zone of the moving object. As a specific example, although a user has low grade information which does not consider assignment of an adjacent zone while a high-end sedan is disallowed but requests a high-end new-model sedan as a detailed option of the use request, the server may not consider the detailed option of the user. More specifically, the server may inquire about an available moving object from sedans lower than the high-end sedan, and determine a moving object of a zone which is not adjacent to the position information of the user when the use request of the user overlaps that of a user having a higher grade than the user.

As another example, other information of the use request may be usage pattern information. The use request may be a message generated as a combination of the user position information and the usage pattern information or usage pattern information without the position information, together with the moving object use time.

The usage pattern information may be generated by collecting at least one of life pattern information or riding pattern information for each user, as described above.

The usage pattern information may be set by the user before or at the time of the use request and generated in the use request message. In addition, the usage pattern information may be estimated from travel position information of the moving object obtained according to a user's content, a user's purchase/transaction data for goods and services during the moving object use time, an image acquisition device mounted in the moving object, and riding information recognizable from communication between identification devices of the user device of all of a driver and passengers and the moving object, such as ultra wide band (UWB), beacon, Bluetooth or Wi-Fi. The life pattern information and the riding pattern information may be inferred by at least one of the travel position information, the purchase/transaction data or the riding information. For example, the travel position information may include a stopping place, a destination and a parking/stopping place of the user through the moving object and include a shopping mall, a hospital or a specific building for a business trip visited by the user. The purchase/transaction data may be a list of goods and services purchased and consumed by the user at the moving object use time. The goods may be purchased at a shopping mall, market, outlet, clothing store, etc. and the services may be cultural services such as hospital visit, movie or concert. The life pattern information may be determined based on the list of goods/services purchased/consumed with high frequency during a recent moving object use time. For example, when payment information frequently occurs recently in a university hospital, an orthopedic clinic or a hospital related to a special disease, the life pattern information may be set by applying a weight to a hospital service compared to the other items by referring to the recent payment information. The usage pattern information of a specific user may be determined by considering not only payment information but also travel position information checked by hospitals which has recently been frequently visited and riding information of an elderly person which has ridden to visit the hospital during the moving object use time. Of course, since the travel position information and the purchase/transaction data and the riding information are changed over time, a higher weight is applied to the above-described information obtained using the recent use time of the user than previous information, ranking information on a plurality of positions, purchased items and passengers included in the usage pattern information.

When the use request is a message including the life pattern information, the server may determine the assignment condition of the moving object according to the life pattern information of the user who has requested use. For example, the server may determine that the user has purchased a large amount of goods and spent a lot of money in a specific shopping mall as a result of inquiring into the recent stopping place, destination and purchase/transaction data of the user and may determine an available moving object and the zone of the moving object satisfying the assignment condition including the type, specification, production year, cleanliness and assignment zone of the moving object, if the use request is a message including a shopping mall as the planned travel position. In the above-described example, when the life pattern information of the user who has requested use includes purchase of a large amount of goods in the shopping mall, the server may select an available moving object of an SUV type capable of loading a large amount of goods and having a model of 3 to 4 years ago and a cleanliness condition of medium or higher. Considering that, in the fleet system, moving objects are arranged such that assignment and return zones are as much the same as possible, the server may present the selected moving object from a zone as close as possible to the user's residence. Therefore, the user may return the moving object to the return zone close to the user's residence, such that the user may carry the large amount of purchased goods to their residence in a short distance.

As another example, as a result of inquiring into the usage pattern information of the user who has requested use, when a middle-aged driver has periodically visited a specific hospital with an elderly passenger recently and there is hospital service payment information, if the request is made such that the moving object use time substantially matches the hospital vising period, the server may determine an available moving object and the zone of the moving object satisfying the assignment condition including the type, specification, production year, cleanliness and assignment zone of the moving object based on the usage pattern information. In the above-described example, the server may select an available moving object of a medium or larger sedan type that a plurality of passengers can ride with a comfortable ride, a latest model and a superior cleanliness condition or higher. For convenience of use of the elderly passenger, the server may sequentially present the selected moving object from a zone as close as possible to the user's residence.

As another example, the server 200 may receive maintenance information from the moving object 300 suitable for the use request and receive maintenance scheduling information from a maintenance server. The server 200 may exclude a moving object having a moving object use time overlapping the maintenance time of the moving object 300 from the list, by referring to the maintenance scheduling information. In addition, the server 200 may select the moving object 300, by referring to the grade information of the user, weather information expected for the use time and the maintenance information. In addition, when a destination and a stopping place are received through the use request, the server 200 may select a moving object by referring to planned travel information along with the above-described information. Specifically, the grade information may include evaluation information for estimating the moving object driving pattern of the user. The moving object driving pattern may include the frequency of accidents and inappropriate use of the moving object which may cause maintenance, sudden stop/speeding which may cause rapid consumption of parts of the moving object, smoking which may cause poor cleanliness, loading of odorous objects, and the frequency of multiple passengers. The moving object driving pattern may be checked by finding causes in the maintenance process or may be checked from sensor data detected by various sensors mounted in the moving object. The maintenance information may include a demand for maintenance of each part of the moving object, and the server 200 may determine whether the moving object is selected in consideration of change in the demand for the moving object according to the moving object driving pattern estimated from the grade information (or the evaluation information). In addition, the server 200 may predict the change in demand by referring to a weather environment during travel, road surface condition, road inclination, etc. of the planned travel route in addition to the grade information, and determine whether to select the moving object according to the change.

Next, the server may receive reservation information based on the moving object selected by the user device from the list of the available moving objects.

As described above, the list of the available moving objects may be represented by a combination of the zones where the moving objects are arranged and a plurality of moving objects selected by referring to a message including the moving object use time alone in the use request or, together with the use time, at least one of the position information of the user, the type of the moving object, the history information, the preference information, the grade information, the life pattern information of the user and the riding pattern information of the moving object.

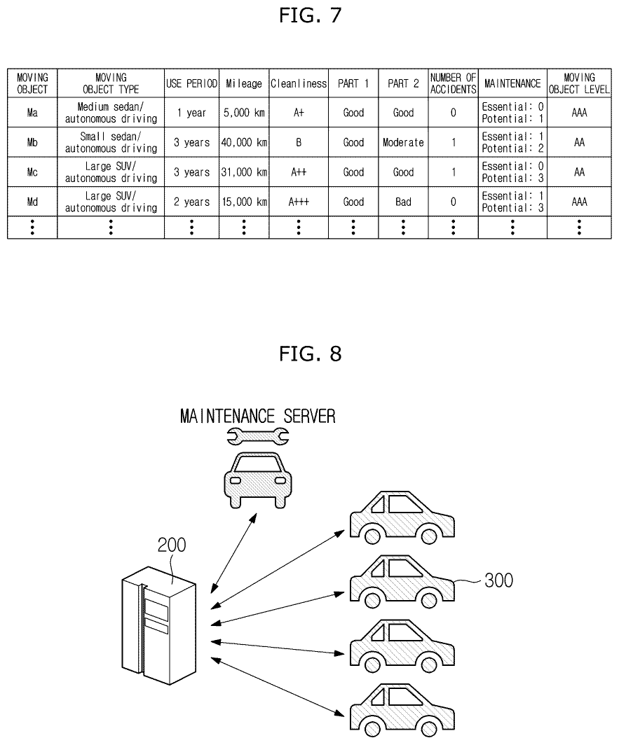

The list of available moving objects may provide the user device 100 with moving object overview information shown in FIG. 7, specifically, overview information related to maintenance of each moving object, and the user device 100 may check the moving object overview information. FIG. 7 is a view showing an example of moving object overview information. The moving object overview information may include, but is not limited to, maintenance information showing cleanliness, schematic states of major parts and a demand for maintenance along with an accumulated use time and an accumulated mileage.

Subsequently, the server 200 may assign the moving object 300 to the user device 100 based on the reservation information. Here, the user device 100 and the moving object 300 may be notified of the reservation information.

The user device 100 may authenticate the moving object 300 for use start, and the user device 100 may control the moving object through start authentication. A start authentication message may be transmitted to the server 200, and the server 200 may check activation of the moving object 300. The moving object 300 may transmit information generated in the use process to the server 200 and the user device 100 from a use start time point to a predetermined time from use end, and the server 200 may transmit related information to the moving object 300 and the device 100. For example, the moving object 300 may transmit position information, travel route information, stopping place information, surrounding object information, surrounding environment information and maintenance related information, but is not limited thereto. The server 200 may transmit overall information related to use, control and return of the moving object, evaluation information after use and information on a response to the maintenance request transmitted from the moving object 300, but is not limited thereto. In the following embodiment, information related to the maintenance process will be focused upon. FIG. 8 is a view illustrating an example of performing maintenance level analysis and maintenance request between a moving object and a server. As shown in FIG. 8, the moving object 300 and the server 200 may exchange maintenance related information, evaluation information, information related to control and return of the moving object during use, until a predetermined time from use end.

After start of use, the moving object 300 and the server 200 may perform the maintenance process and, if necessary, related information may be transmitted to the user device 100 and response information may be received from the device 100. In relation to the maintenance process, the moving object 300 may obtain monitoring information of each part. The moving object 300 may analyze a maintenance level of each part from the monitoring information and check whether there is a part corresponding to an essential level or a potential level as the maintenance level. When the part reaches the essential level or parts reach the potential level and a predetermined condition is satisfied, the moving object 300 may determine whether to maintain the part of the moving object. When maintenance is determined, the moving object 300 may request maintenance of the part from the server 200. In addition to data generated regardless of use of the moving object, such as the accumulated use period data of the moving object, data included in the monitoring information is generated during use and thus may be generated in real time during use. However, the process after generating the monitoring information may be performed during, before or after use. When the process is before and after use, if a predetermined event occurs after monitoring information accumulated through past use is stored in the moving object 300, a subsequent process may be performed based on the accumulated monitoring information. The predetermined event may be, for example, arrival of a certain period or a request of the server 200.

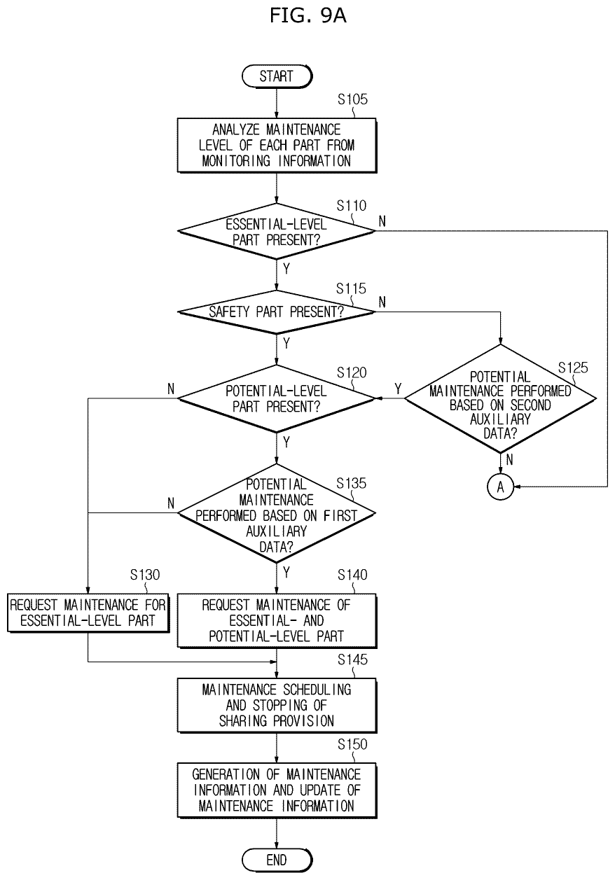

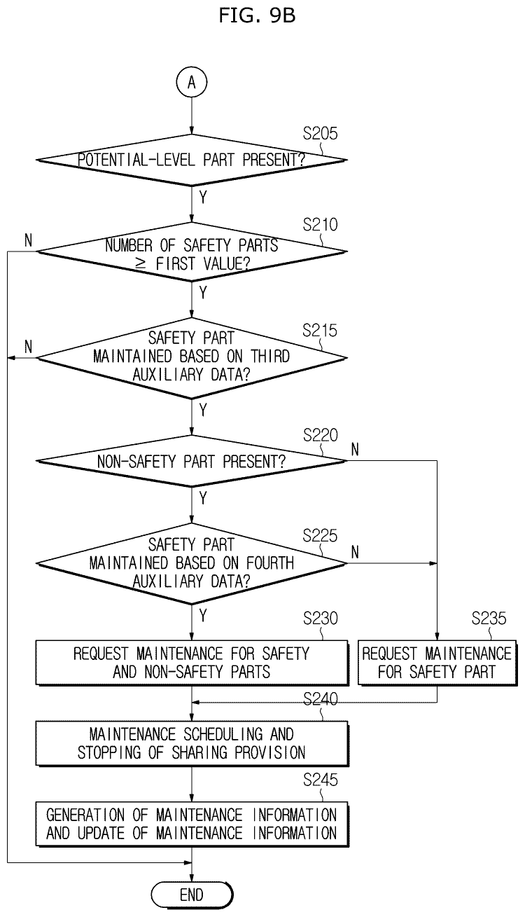

The maintenance process will be described in detail with reference to FIGS. 9A and 9B.

Meanwhile, the user device 100 may transmit a return request such that end of use of the moving object 300 may be confirmed by the server 200. The monitoring information may be generated and accumulated until end of use is confirmed. In addition, the moving object 300 may generate and transmit basic evaluation information to the server 200 until the end, and the server 200 may generate evaluation information. When the evaluation information changes the grade information, the server 200 may update the grade information and transmit the updated grade information to the user device 100 and the moving object 300.

For example, the moving object 300, which has received an end confirmation message from the server 200, may generate the basic evaluation information. The basic evaluation information may include, for example, severe use data of the moving object 300, cleanliness data after use of the moving object 300, maintenance data after use of the moving object 300, accident data after use, and evaluation data of a subsequent user. Data of the basic evaluation information may be detected or recorded by maintenance data received from a maintenance server or the sensor or camera mounted in the moving object 300. Although, in the present embodiment, the basic evaluation information is described as being generated by the moving object 300, the user device 100 may generate and transmit the basic evaluation information such as poor cleanliness or expedited cost processing due to maintenance to the server 200.

The server 200 may generate and update the evaluation information based on the basic evaluation information. Since the evaluation information is, for example, information shown in FIG. 3, a detailed description thereof will be omitted.

The server 200 may determine whether the grade information of the user may be maintained or changed based on usage status information for the use condition of the moving object and the updated evaluation information and update the grade information according to the result of determination. The usage status information may include, for example, contract information of the user registered in the fleet system. The contract information may include not only a subscription period and a long-term deposit but also specific request information for rapidly resolving use discontinuation of use of a poorly used moving object, for example, rapid processing subscription information such as cleanliness and maintenance.

In addition, the server 200 may determine the benefit and penalty according to the grade information.

This may be changed by the usage pattern of the user, the state of the moving object or the requests of the user and the operator. For example, a user corresponding to a highest grade level may be assigned a moving object in a range from highest-level to low-level moving objects. For example, when there is a use request in which a user designates only a use time, the server may set moving objects having predetermined grades from a highest grade among moving objects available at the corresponding time to be included in the list of available moving objects. When there is a use request in which a user corresponding to a highest grade level designates only a use time, a moving object satisfying all possible conditions of production year, cleanliness and the benefit condition of assignment zone among moving objects with highest and best grade levels may be determined to be presented. The benefit is described above, may be related to the direct conditions of the moving object, such as moving object function, production year, and cleanliness, and may be an additional service for convenience of the fleet service. The additional service may also be differentiated according to the grade level. For example, when the use request of a user with a highest grade level overlaps that of a user with a low grade level, the user with the highest grade level may be recommended for the moving object of an adjacent zone in preference to the user with the low grade level. In addition, a user with a high grade level may use a frequently used specific moving object based on the history information and the preference information and may designate a parking surface convenient thereto as needed. In addition, the server 200 may limit some of benefits which may be obtained at a current grade level, by applying a penalty to the inappropriate use of the user and decrease the grade level when the penalties are accumulated. However, when the server determines the inappropriate use of the user, if an idle degree such as the moving object maintenance time and cost due to maintenance is equal to or less than a predetermined value, the applied penalty may vary according to the grade level. In addition, if cleanliness deterioration and part consumption are equal to or less than a reference value of each part, the applied penalty may vary according to the grade level. However, when inappropriate use of the moving object occurs due to a user's negligence, the penalty may be set to be applied regardless of the grade level.

Although the grade information decreasing according to the applied penalty was focused upon in the above description, when a user performs activities such as a user's long-term contract at the time of renewal, a large amount of deposit, lower consumption rate than a normal consumption rate (reference value) of moving object parts due to the user's act of using the moving object better than the other users, long-term accident-free, or cleanliness increase due to clean use of the moving object or cleaning, the server may adjust the usage status information and the evaluation information based on the above activities and increase the grade level (grade information).

As described above, when the evaluation information and the grade information are updated, the server 200 may transmit the information to the user device 100 and the moving object 300 and thus the moving object 300 and/or the server 200 may determine whether use of the moving object used by the user is limited.

FIGS. 9A and 9B are flowcharts illustrating a maintenance method of a moving object according to an embodiment of the present disclosure.

Referring to FIG. 9A, the moving object 300 may obtain monitoring information of each part during use and analyze a maintenance level of each part from the monitoring information (S105).

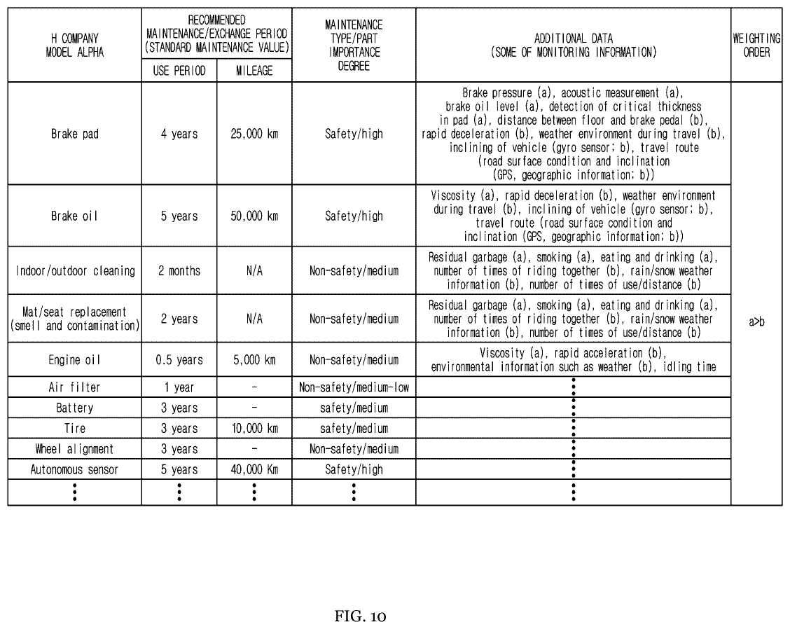

The monitoring information may be data capable of estimating the state of a part to be maintained and, specifically, may be factor data for detecting a state affecting part consumption or defect occurrence or a state close to abnormality of a part. The monitoring information may include mileage data and use period data. As shown in FIG. 10, the maintenance period of a part depends on the mileage and the use period and thus may be used as a basic factor. FIG. 10 is a view illustrating an example of basic information of each part of a moving object.

For example, the mileage data and the use period may be cumulative mileage and the cumulative use period (or production year) of the moving object. In this case, the cumulative mileage and the cumulative use period are commonly applied to each part. When maintenance of the part occurs by replacement or repair of a specific part, the moving object 300 and the server 200 may check a maintenance occurrence point and obtain the mileage data and the use period data of the part by referring to the checked point in the commonly applied mileage and use period. As another example, the moving object 300 may initially count the mileage data and the use period data for each part. When maintenance occurs in a specific part, the moving object 300 may count the mileage and period by updating the start point of the mileage and use period of the part to a maintenance occurrence point.

As another example, the monitoring information may further include additional data for measuring or estimating severe use of each part, in addition to the mileage and the use period. The severe use may include not only severe use of the part by the user but also the use of the part in a state close to abnormality of the part. The additional data may have detailed data which differ between parts. The detailed data is not fixed and may be changed through machine learning for data accumulated by using the moving object, and the changed data may be transmitted to the moving object 300 by the server 200.

For example, in the brake pad of FIG. 10, the maintenance period of the brake pad in a normal use environment, that is, a normal maintenance period of the brake pad, may be a use period of four years or a mileage of 25,000 km corresponding to the standard maintenance value. If severe use of the brake pad occurs while the moving object is used, the brake pad may be in an excessive consumption or defective state in which normal use is substantially impossible before reaching the normal maintenance period. Furthermore, a defect in the brake pad may be a fatal defect in safety of the moving object, and the brake pad may correspond to a safety part related to safety of using the moving object (that is, a part belonging to a first part class and hereinafter referred to as “safety part”). Therefore, the maintenance time of the brake pad due to severe use may occur earlier than the normal maintenance period. The monitoring information may include additional data in order to detect a situation in which maintenance is required at a time point different from the normal period. The additional data of the brake pad may include, but is not limited to, brake pressure, acoustic measurement, brake oil level, detection of a critical thickness in the pad, a distance between an indoor floor of the moving object and a brake pedal, rapid deceleration, weather environment during travel, inclining of a vehicle during use, or a travel route, as shown in FIG. 10.

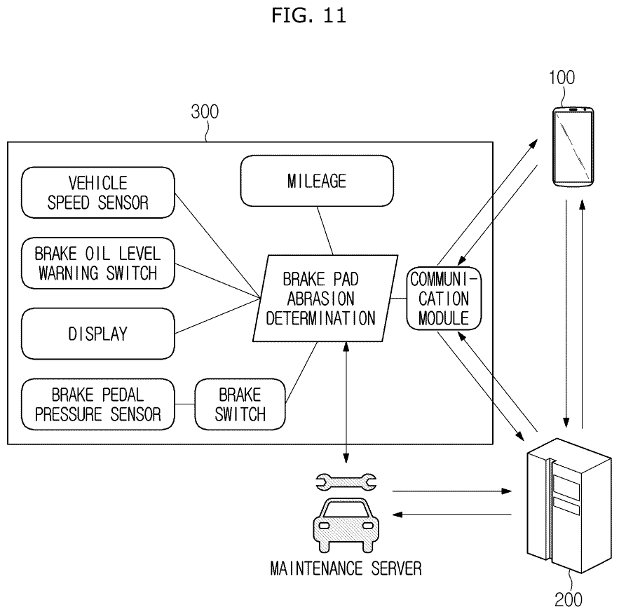

The monitoring information may be generated by information received from the measurement device, sensor, external and internal camera of the moving object 300 or an external device. FIG. 11 is a view illustrating a moving object module for measuring a maintenance level of a brake pad and a process of transmitting monitoring information. For example, in acquisition of the information on the brake pad shown in FIG. 11, the brake pressure, the brake oil level, detection of the critical thickness in the pad, the distance between the indoor floor of the moving object and the brake pedal may be measured or detected by a brake pedal pressure sensor, a brake oil level warning switch, a lining/pad gap sensor and a brake switch as devices mounted in the moving object 300. In addition, acoustic measurement, rapid deceleration, inclining of the vehicle during use, and the travel route may be respectively detected by an acoustic recognition sensor, a vehicle speed sensor, a wheel speed sensor, a gyro sensor, and a GPS device as devices mounted in the moving object 300. The surrounding environment information may be, for example, weather information on the travel route and may be acquired from a moving object, an RSU, a device, a base station or a cloud around the route. In addition, the surrounding object information may include, for example, a road surface condition and an inclination on the route, and may be acquired from precise road map data received from the outside or an external camera and an IMU/gyro sensor mounted on the moving object.

As described above, the moving object 300 may analyze the maintenance level of each part from the monitoring information.

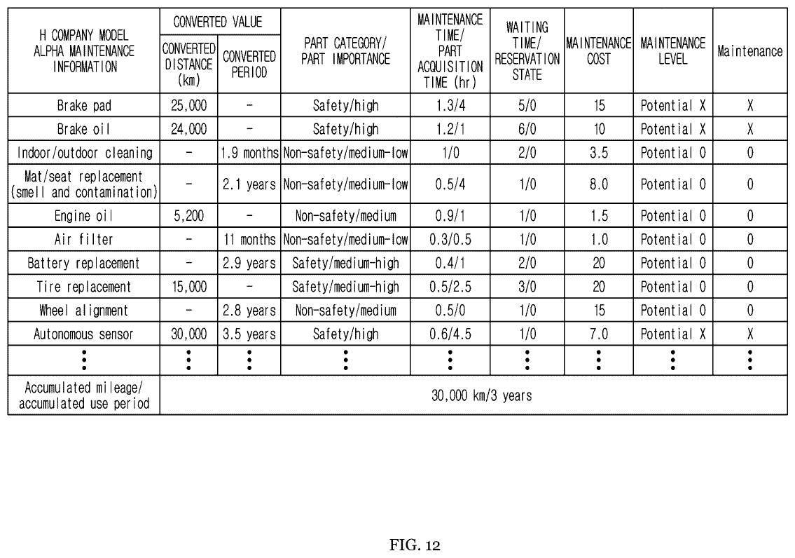

For example, the maintenance level is the monitoring information acquired for each part and may be analyzed based on mileage data and use period data. Specifically, the moving object 300 may determine the mileage and period accumulated during use as the converted mileage and the converted period shown in FIG. 12. FIG. 12 is a view illustrating an example of maintenance information of a moving object. In this case, the converted value expressed by the converted mileage and the converted period may be calculated as an actual value indicated by an actual mileage and use period without including additional information. That is, the maintenance level may be analyzed by the actual value.

As another example, the moving object 300 may determine that the part is severely used by analyzing the additional data of the part, and analyze the maintenance level by adding additional data to the actual value. Therefore, the moving object 300 may give weights reflecting a degree of influence on part consumption and defect occurrence to detailed data configuring the additional data of the part. Alternatively, the weight data may be transmitted to the server 200, and the server 200 may transmit the weight data updated through machine learning of the data accumulated in the process of using the moving object to the moving object 300. For example, in the brake pad of FIG. 10, the brake pressure, the acoustic measurement, the brake oil level and detection of the critical thickness in the pad may correspond to detailed data capable of checking a state close to abnormality of the part and thus have higher weight a than the other detailed data. In addition, the rapid deceleration, the weather environment during travel and inclining of the vehicle may correspond to detailed data occurring by inappropriate use of the user and thus have a lower weight b than the other detailed data.

When the maintenance level is analyzed by including the additional data, to which the weight is given, as shown in FIG. 12, the moving object 300 may calculate the converted value of each part, which is obtained by adding the additional data to an actual value. In this case, the converted value is different from the actual value and may be a value obtained by adding the additional data used for determination of severe use to the actual value.

Next, the moving object 300 may check whether there is a part corresponding to an essential level or a potential level as the maintenance level.

The essential level is a level requiring maintenance of the part. When the converted value of the part is equal to or greater than the standard maintenance value, the moving object 300 may determine the part as the essential level. When there is no severe use, the converted value is equal to the actual value of at least one of the mileage data or the use period data of the part, and a part having an actual value equal to or greater than the standard maintenance value may be checked as the essential level. As another example, upon determining that there is severe use, the converted value is a value calculated by a combination of the actual value and the additional data, and a part having a calculated actual value equal to or greater than the standard maintenance value may be checked as the essential level. In this case, even if at least one of the mileage data or use period data of the part is less than the standard maintenance value, the maintenance level of the part may reach the essential level.

The potential level is lower than the essential level, and the moving object 300 may determine a part having a converted value reaching a predetermined ratio of the standard maintenance value as the potential level. The predetermined ratio may be differently set according to the characteristics of the part. For example, the potential level of an engine oil may be set to a converted value corresponding to about 95% of the standard maintenance value in consideration of a non-safety part.

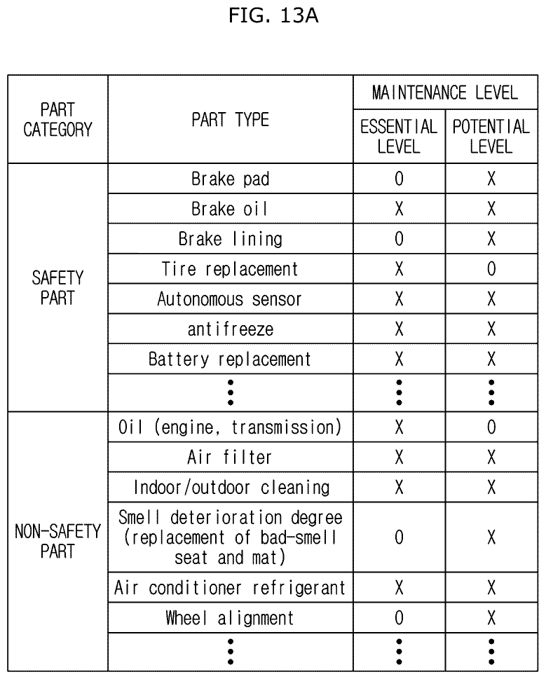

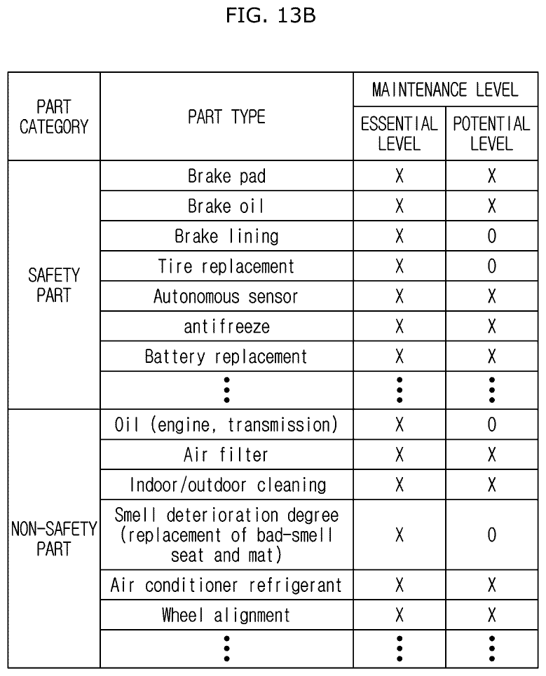

The moving object 300 may calculate a converted value as the maintenance level for each part and then compare the converted value with the standard maintenance value to check whether it is an essential level or potential level for each part. The moving object 300 may generate and store checking result information of each part, as shown in FIGS. 13A and 13B. FIGS. 13A and 13B are views illustrating an example of a maintenance level. In addition, the moving object 300 may record and store not only the essential or potential level information but also maintenance related information of each part in the form of a table, as shown in FIG. 12. The maintenance related information may further include resource information required for maintenance, usage status information of the moving object and a part category in addition to the level information. The resource information may include, for example, an expected part maintenance time, a part acquisition time, a maintenance waiting time and maintenance cost and may be received from the server 200. The usage status information may be, for example, a subsequent reservation state of the moving object and may be received from the server 200.

Next, the moving object 300 may check whether there is a part having an essential level as the result of analyzing the maintenance level (S110). Upon determining there is a part having an essential level as the result of checking as shown in FIG. 13A, the moving object 300 may check whether there is a safety part among the parts checked as the essential level again (S115). If there is no part having the essential level, operation of the moving object 300 may transition to the process shown in FIG. 9B. The safety part is related to safety of use of the moving object and may cause a serious risk to the safety of the moving object if maintenance is not performed when the standard maintenance value is reached. Parts belonging to a second part class having lower safety requirement than the first part class, that is, non-safety parts, may not cause risk to the safety of the moving object or impede use of the moving object even if maintenance is overlooked as error when the standard maintenance value is reached or even if the converted value exceeds the standard maintenance value in a predetermined value range. The safety and non-safety parts may be classified according to the part category shown in FIG. 12.

When the essential-level part includes a safety part, the moving object 300 may determine whether at least one part other than the essential-level part has a potential level (S120).

Upon determining that there is no potential-level part, the moving object 300 may determine maintenance of the safety part of the essential level and transmit a maintenance request message to the server 200 (S130).

Upon determining that there is a potential-level part in step S120, the moving object 300 may determine whether to maintain the potential-level part based on first auxiliary data (S135). The first auxiliary data may have at least one of resource information required for maintenance of the potential-level part or the usage status information of the moving object. The resource information and the usage status information may be substantially equal to the above-described examples. For example, in the resource information related to battery replacement shown in FIG. 12, the moving object 300 may include a maintenance time required for battery replacement, a part acquisition time, a waiting time and maintenance cost as maintenance information updated to a latest state. The moving object 300 may determine that the potential-level battery is not replaced, upon determining that the part acquisition time or waiting time for battery replacement is significantly greater than an average value. Unlike the reservation situation of the moving object shown in FIG. 12, when the number or time of reservations of the moving object is large or when the number or time of reservations of the moving object is small but the number of moving objects for replacement is small, the moving object 300 may determine that the potential-level battery is not replaced.

In the resource information, when a part is a non-safety part, the first auxiliary data may further include characteristic information of the part. The characteristic information of the part may have at least one of the characteristic information of the moving object. The characteristic information may be set, for example, for each non-safety part and may be information defining a predetermined ratio exceeded from the essential level. For example, the predetermined ratio of the characteristic information may be set not to exceed at least one of a safety level or discomfort level defined for each non-safety part, and the characteristic information may be received from the server 200. For example, in the discomfort level, when the number of discomfort messages of the user for the non-safety part is equal to or greater than a reference value, it may be statistically determined that the part causes the discomfort of the user. Here, the reference value is not fixed and may be periodically adjusted. The predetermined ratio of the characteristic information according to the discomfort level may be calculated as an excess ratio of the standard maintenance level (or essential level) when the number of discomfort messages is equal to or greater than the reference value. Specifically, the recommended replacement period (essential level) of the seat is two years. However, when it is statistically determined that the number of discomfort messages of users rapidly increases when a period of about 2.6 years elapses, the predetermined ratio of the characteristic information of the seat may be set to 1.3 times.

When there is a plurality of potential-level parts, the moving object 300 may determine maintenance with respect to some of the plurality of parts. In this case, the moving object 300 may determine that maintenance is not performed with respect to some potential-level parts.

When the moving object 300 determines maintenance of at least one potential-level part in step S135, the moving object 300 may transmit a maintenance request message for the essential-level safety part and the potential-level part, maintenance of which is determined, to the server 200 (S140).

When the server 200 receives the maintenance request message in steps S130 and S140, the server 200 may transmit a maintenance request to the maintenance server 200 to reserve maintenance of the part of the moving object 300, and control the user device 100 and the moving object 300 to stop provision of the moving object 300 until maintenance is completed (S145). The maintenance server 200 may generate maintenance scheduling of the moving object 300 according to the request. Maintenance scheduling may be organized in consideration of maintenance information of the corresponding moving object and the other moving object and overall maintenance status information.

Next, when maintenance of the part of the moving object 300 is completed, the maintenance server 200 may update the maintenance information of the maintained part and transmit the updated information to the server 200 and the corresponding moving object 300 (S150). As another example, the maintenance server 200 may transmit only the maintenance information of the maintained part to the server 200 and the moving object 300, and the moving object 300 and the server 200 may perform the update by applying the information to the maintenance information prestored in the moving object 300.

On the other hand, upon determining that the essential-level part does not include a safety part in step S115, the moving object 300 may determine whether to maintain an essential-level non-safety part based on second auxiliary data (S125). The second auxiliary data may have at least one of resource information required for maintenance of the non-safety part, usage status information of the moving object or the characteristic information of the moving object. The resource information, the usage status information and the characteristic information may be substantially equal to those described above.

In relation to the characteristic information of the non-safety part, exchange of engine oil corresponding to the non-safety part will be described with reference to FIG. 12. Even if the converted mileage of the engine oil exceeds the standard maintenance value to reach the essential level, when determining that the converted mileage does not affect safety in a range of 1.5 times of the standard maintenance value, the moving object 300 may determine that engine oil exchange is not requested. When a mat and a seat corresponding to the non-safety part will be described with reference to FIG. 12, even if the mat and the seat reach the essential level, upon determining that the converted period does not cause significant discomfort to the user in a range of 1.3 times of the standard maintenance value, the moving object 300 may determine that replacement of the mat and seat is not requested. For example, discomfort may be applied when the number of users who has transmitted discomfort messages due to a non-safety part is equal to or greater than a reference value or may be based on a result of analysis from a detailed status message of a non-safety part transmitted by the user (e.g., image photos of the non-safety part). Specifically, even if the mat and the seat reach the essential level, upon determining that the number of discomfort messages due to cleanliness and smell of the mat and the seat is less than the reference value or the seat is available without replacement as the result of analysis from the image of the seat, the server 200 may determine that significant discomfort is not caused.

When maintenance is determined with respect to the essential-level non-safety part in step S125, the moving object 300 may perform the operation of step S120. In contrast, upon determining that maintenance is not performed, operation of the moving object 300 may transition to the process of FIG. 9B.

The process of FIG. 9B may start from step S205 of determining whether there is a potential-level part, when there is no essential-level part in steps S110 and S125. Upon determining that there is no potential-level part, the moving object 300 may provide current or future use and may not generate a maintenance request.

Referring to FIG. 9B, upon determining that there is a potential-level part as shown in FIG. 13B, the moving object 300 may determine whether the potential-level part includes a safety part and determine whether the number of safety parts is equal to or greater than a first value (S210). Upon determining that the potential-level part does not include a safety part, the moving object 300 may determine whether to maintain the essential-level non-safety part based on the second auxiliary data (S125). The moving object 300 may determine whether to maintain the potential-level safety part based on third auxiliary data (S215). The third auxiliary data may have at least one of resource information required for maintenance of the safety part, the usage status information of the moving object or the characteristic information of the moving object. The resource information, the usage status information and the characteristic information may be substantially equal to those described above. When there is a plurality of safety parts, it may be determined that the part is maintained, only when the number of safety parts, safety maintenance of which is determined, is equal to or greater than the reference value. Here, the reference value may be set to be smaller than the first value.

When the moving object 300 determines that maintenance of the potential-level safety part is not performed, the moving object 300 may provide current or future use and may not generate a maintenance request.

In contrast, upon determining that maintenance of the potential-level safety part is performed, the moving object 300 may further determine whether there is a potential-level non-safety part (S220). When there is a non-safety part, the moving object 300 may determine whether to maintain the essential-level non-safety part based on fourth auxiliary data (S225). The fourth auxiliary data may have at least one of resource information required for maintenance of the non-safety part, the usage status information of the moving object or the characteristic information of the moving object. The resource information, the usage status information and the characteristic information may be substantially equal to those described above. When maintenance of the non-safety part is determined, the moving object 300 may transmit a maintenance request message for the potential-level safety and non-safety parts determined as the result of determination to the server 200 (S230).

Meanwhile, upon determining that there is no potential-level non-safety part or maintenance of the non-safety part is not performed in steps S220 and S225, the moving object 300 may transmit a maintenance request message for the potential-level safety part determined as the result of determination to the server 200 (S235).

When the server 200 receives the maintenance request message in steps S230 and S235, the server 200 may transmit the maintenance request to the maintenance server 200 to reserve maintenance of the part of the moving object 300 and control the user device 100 and the moving object 300 to stop provision of the moving object 300 until maintenance is completed (S240). The maintenance server 200 may generate maintenance scheduling of the moving object 300 according to the request (S240). Maintenance scheduling may be organized in consideration of maintenance information of the corresponding moving object and the other moving object and overall maintenance status information.

Next, when maintenance of the part of the moving object 300 is completed, the maintenance server 200 may update the maintenance information of the maintained part and transmit the updated information to the server 200 and the corresponding moving object 300 (S245). As another example, the maintenance server 200 may transmit only the maintenance information of the maintained part to the server 200 and the moving object 300, and the moving object 300 and the server 200 may perform the update by applying the information to the maintenance information prestored in the moving object 300.

If maintenance is performed regardless of the use of the moving object and the maintenance state when the number of parts, the maintenance period of which has arrived, is small, management burden of maintenance in the fleet system increases and the operation rate of the moving object decreases. However, according to the present embodiment, since an optimal maintenance process is performed according to the attributes, maintenance level and use and maintenance state of the part, management burden of maintenance may decrease and the operation rate of the moving object may increase.

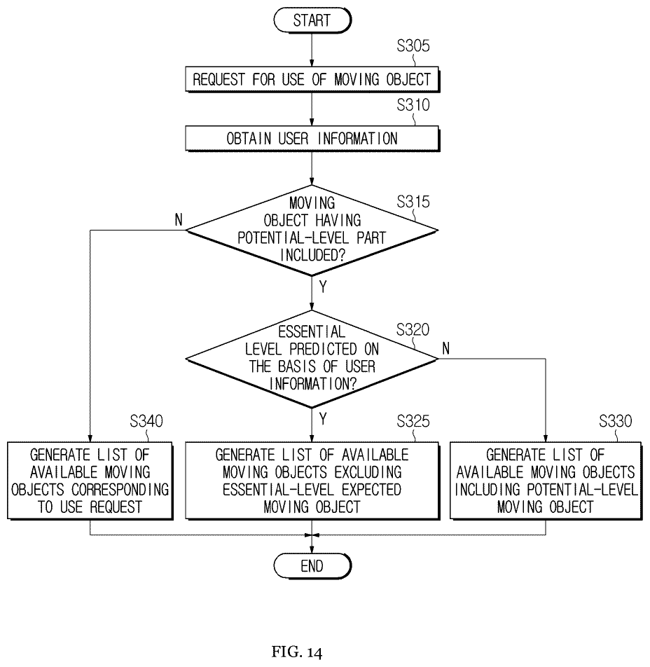

FIG. 14 is a flowchart illustrating a moving object assignment process according to another embodiment of the present disclosure.

The server 200 may receive a use request from the user device 100 (S305). The use request may be substantially equal to that described with reference to FIG. 6. Subsequently, the server 200 may obtain user information related to the requesting device 100 (S310). The user information is an accumulated use information of the user and may include, for example, at least one of grade information including evaluation information, history information or usage pattern information. Next, the server 200 may generate a temporary list of available moving objects suitable for the use request and determine whether moving objects having parts having at least a potential level or more are included in the temporary list (S315). Here, at least the potential level or more may mean a potential level or an essential level. For confirmation, the server 200 may receive maintenance information from the moving object 300 in the temporary list, and the server 200 may check the maintenance level of the part of the moving object as the maintenance information. Upon determining that the moving object 300 having the part having the potential level or more is included in the temporary list, the server 200 may determine whether the maintenance level of the part is predicted as an essential level at the time of using the moving object based on the user information (S320). Upon determining that an essential level is predicted, the server 200 may generate and provide a list of available moving objects excluding the corresponding moving object to the user device 100, such that use of a moving object predicted to have an essential level is disallowed (S325). Upon determining that there is no moving object having an essential level, the server 200 may generate and provide a list of available moving objects including a moving object having a potential level to the user device 100 (S330). Meanwhile, upon determining that there is no moving object having the potential level in the temporary list in step S315, the server 200 may provide the list of available moving objects suitable for the use request to the user device 100 to be the same as the temporary list (S340).

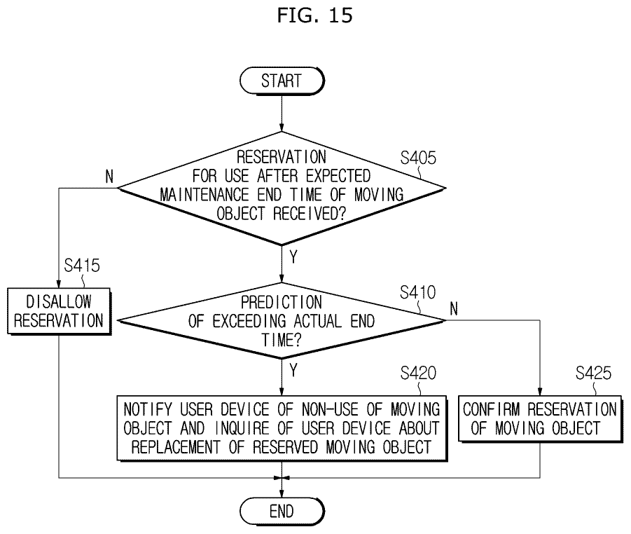

FIG. 15 is a flowchart illustrating a moving object assignment process according to another embodiment of the present disclosure.

When the server 200 receives a reservation for use after an expected maintenance end time of the moving object 300 from the user device 100 (Y to S405), the server 200 may determine whether an actual end time of the moving object 300 is exceeded (S410). Upon determining that the actual end time is exceeded, the server 200 may notify the user device 100 of non-use while cancelling the reservation for the use of the moving object 300 and inquire of the user device 100 about replacement of the reserved moving object (S420). Upon determining that the actual end time is not exceeded, the server 200 may confirm the reservation of the requested moving object (S425). When the server 200 does not receive a reservation for use after an expected maintenance end time of the moving object 300 from the user device 100 (N to S405), the server 200 may disallow the reservation (S415).

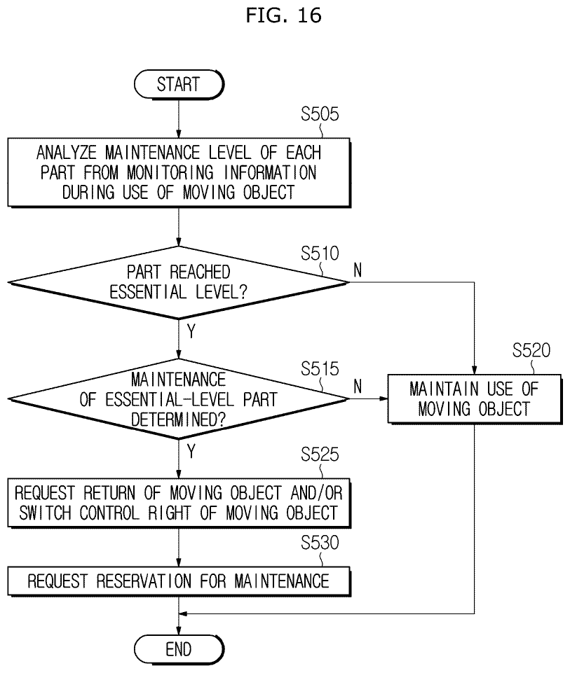

FIG. 16 is a flowchart illustrating a maintenance determination and moving object control method while using a moving object according to another embodiment of the present disclosure.

The moving object 300 may obtain the monitoring information of the part during use and analyze a maintenance level of each part (S505). Subsequently, it may be determined whether there is a part reaching an essential level while the moving object is used (S510). Upon determining that there is an essential-level part, the moving object 300 may determine whether to maintain the essential-level part (S515). This determination is substantially equal to the process of determining maintenance in FIGS. 9A and 9B. When maintenance of the essential-level part is determined, at least one of the moving object 300 or the server 200 may transmit a return request message to the user device 100 (S525). Simultaneously or alone, at least one of the moving object 300 or the server 200 may be set to perform switching of the control right of the moving object (S525). Subsequently, at least one of the moving object 300 or the server 200 may request a reservation for maintenance from the maintenance server 200 (S530). Upon determining that it is N in steps S510 and S515, the moving object 300 may maintain use (S520).

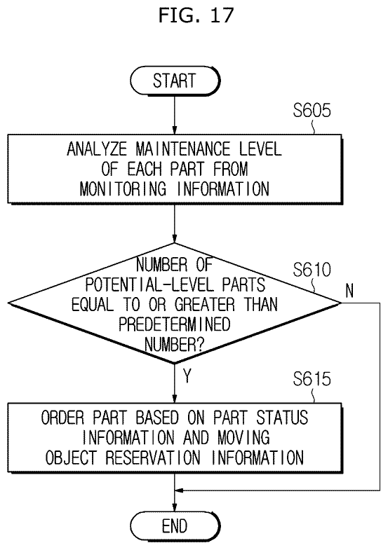

FIG. 17 is a flowchart illustrating a part ordering method according to an embodiment of the present disclosure.

Each moving object 300 may analyze a maintenance level of each part from monitoring information (S605). Each moving object 300 may determine whether the number of potential-level parts is equal to or greater than a predetermined number (S610). In this step, the server 200 may receive information related to the potential-level parts from each moving object to collect the types and number of potential-level parts from all moving objects 300. When more than a predetermined number of parts reaches the potential level, at least one of the moving object 300 or the server 200 may order a part based on at least one of part status information for inferring the stock of the potential-level parts and reservation information of the moving object (S615). The part status information may be configured based on the stock information of the maintenance server and/or the resource information of the maintenance information. When less than the predetermined number of parts has a potential level, the moving object 300 and/or the server 200 may not make a request for ordering parts.

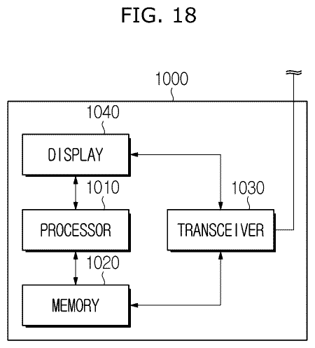

FIG. 18 is a view illustrating the configuration of a device according to an embodiment of the present disclosure. Referring to FIG. 18, the device may include at least one of the above-described moving object, device, server or RSU. That is, the device may perform communication with another device and may be linked to another device, and is not limited to the above-described embodiment. For example, the device may include at least one of a processor 1010, a memory 1020, a transceiver 1030 or a display 1040 for the above-described operation. That is, the device may include components necessary to perform communication with another device or display a mutual data processing result. In addition, for example, the device may include components other than the above-described components. That is, the device includes the above-described components to perform communication with another device, but is not limited thereto, and may operate based on the above description.

While the exemplary methods of embodiments of the present disclosure described above are represented as a series of operations for clarity of description, it is not intended to limit the order in which the steps are performed, and the steps may be performed simultaneously or in a different order as necessary. In order to implement the method according to embodiments of the present disclosure, the described steps may further include other steps, may include remaining steps except for some of the steps, or may include other additional steps except for some of the steps.

The various embodiments of the present disclosure are not a list of all possible combinations and are intended to describe representative aspects of embodiments of the present disclosure, and the matters described in the various embodiments may be applied independently or in combination of two or more.

In addition, various embodiments of the present disclosure may be implemented in hardware, firmware, software, or a combination thereof. In the case of implementing embodiments of the present invention by hardware, embodiments of the present disclosure can be implemented with application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on a device or a computer, a non-transitory computer-readable medium having such software or commands stored thereon and executable on the device or the computer.

What is claimed is:

1. A method of allocating a moving object to be performed by a computing device of a fleet system, the method comprising:
receiving a request for allocating the moving object from a user device;
obtaining user information related to a user of the user device;
generating a temporary list of available moving objects suitable for the request;
receiving maintenance information of a part of the moving object in the temporary list;
computing a maintenance level of the part of the moving object based on the maintenance information;
determining whether the maintenance level of the part is predicted as an essential level during use of the moving object based on the user information; and
providing a final list of available moving objects excluding the moving object predicted having the essential level to the user device.

2. The method of claim 1, wherein the user information includes at least one of grade information, evaluation information, history information, or usage pattern information.

3. The method of claim 1, further comprising:
determining whether moving objects having parts having one of a potential level or the essential level are included in the temporary list.

4. The method of claim 1, further comprising:
based on determining that there is no moving object having the essential level, providing the final list of available moving objects including a particular moving object having a potential level to the user device.

5. The method of claim 4, further comprising:
based on determining that there is no moving object having the potential level in the temporary list, providing the temporary list of available moving objects to the user device.

6. A computing device in a fleet system configured to allocate a moving object, the computing device comprising:
a transceiver configured to transmit and receive a signal; and
a processor configured to:
receive a request for allocating the moving object from a user device;
obtain user information related to a user of the user device;
generate a temporary list of available moving objects suitable for the request;
receive maintenance information of a part of the moving object in the temporary list;
compute a maintenance level of the part of the moving object based on the maintenance information;
determine whether the maintenance level of the part is predicted as an essential level during using the moving object based on the user information; and
provide a final list of available moving objects excluding the moving object predicted having the essential level to the user device.

7. The computing device of claim 6, wherein the user information includes at least one of grade information, evaluation information, history information or usage pattern information.

8. The computing device of claim 6, wherein the processor is further configured to:
determine whether moving objects having parts having one of a potential level or the essential level are included in the temporary list.

9. The computing device of claim 6, wherein the processor is further configured to:
provide the final list of available moving objects including a particular moving object having a potential level to the user device based on determining that there is no moving object having the essential level.

10. The computing device of claim 9, wherein the processor is further configured to:
provide the temporary list of available moving objects to the user device based on determining that there is no moving object having the potential level in the temporary list.

11. A moving object for a fleet system, comprising:
a power source capable of causing the moving object to move;
a wheel;
a plurality of parts including safety parts and non-safety parts;
a transceiver configured to transmit and receive a signal; and
a processor configured to:
control the transceiver;
transmit a request for allocating the moving object to a server of the fleet system; and
receive a final list of available moving objects from the server,
wherein the server generates the final list of available moving objects by:
obtaining user information related to a user;
generating a temporary list of available moving objects suitable for the request;
receiving maintenance information of a part of the moving object in the temporary list;
computing a maintenance level of the part of the moving object based on the maintenance information;
determining whether the maintenance level of the part is predicted as an essential level during using the moving object based on the user information; and
providing the final list of available moving objects excluding the moving object predicted having the essential level to a user device.
